(19) United States
(12) Patent Application Publication
(10) Pub. No.: US 2026/0112353 A1
(43) Pub. Date: Apr. 23, 2026

(54) CUSTOMIZATION OF SOUND PRODUCTION FOR ON-ROAD VEHICLES

(71) Applicant: Volvo Car Corporation, Göteborg (SE)

(72) Inventors: Daniel Young, Göteborg (SE); Derek Boesch, Göteborg (SE); Andrew Fiorino, Göteborg (SE); William Figueroa, Göteborg (SE); Giovanni Spiritoso, Göteborg (SE); Josh Crim, Göteborg (SE); Brian Burgard, Göteborg (SE); Peter Barcia, Göteborg (SE)

(21) Appl. No.: 18/923,933

(22) Filed: Oct. 23, 2024

(51) Int. Cl. G10K 11/18; B60Q 9/00

(52) U.S. Cl. CPC G10K 11/18; B60Q 9/00

(57) ABSTRACT

A system for customization of on-road sound production for a vehicle includes one or more noise generators supported relative to the vehicle and configured to produce a soundscape in an environment of the vehicle. The system further includes memory storing instructions that, when executed by one or more processors, cause the processor(s) to generate the soundscape from a sound file based on an indication of a user-preferred sound file of multiple files, an environmental context surrounding the vehicle, or both. The instructions cause the processor(s) to determine whether an operational status of the vehicle is suitable for on-road operation. The instructions cause the processor(s) to further produce, in response to a determination that the operational status of the vehicle is suitable for on-road operation, the soundscape utilizing the noise generator(s) while the operational status of the vehicle is suitable for on-road operation.

### TECHNICAL FIELD

The present disclosure relates generally to the automotive field. More particularly, the present disclosure relates to customization of on road sound production for a vehicle based on a user preferred sound file and/or the environmental context of the vehicle.

### BACKGROUND

Road worthy vehicles are required to produce noise over regulated limits during use to comply with safety regulations. However, battery electric vehicles (BEVs) and some plug-in Hybrid Electric Vehicles (PHEVs), hybrid electric vehicles (HEVs), and the like naturally produce nearly no noise during use and require active sound production to satisfy such regulations. Some such existing vehicles meet the minimum noise production regulatory requirements, but satisfying this minimum standard is not sufficient to provide the safety desired or required by vehicle producers and end users. Furthermore, existing sound production for such vehicles is one size fits all, preventing user customization. Current sound production for such vehicles does not provide user feedback or feedback control for such noise to account for different operating conditions and environmental factors.

As such, a need exists in the art for a system and associated methods and control systems for vehicles that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a system for customization of on-road sound production for a vehicle and associated methods of operation and control systems that overcome the limitations of the known art.

Embodiments of the disclosed systems and methods facilitate customization of on-road sound production for a vehicle by allowing an occupant to select a preferred sound file or provide the preferred sound file for generation of internal and/or external on-road sound. The generated on-road sound is intended to supplement noise generated by a quiet internal combustion engine, electric engine, or hybrid engine of the vehicle in question. The on-road sound may be generated based on the preferred sound file of the occupant, an environment surrounding the vehicle, an internal environment of the vehicle, vehicle parameter data, or a combination of the above. Thus, operators are permitted to select or provide the source sound files utilized to generate the external or internal on-road sounds, respectively. Based on the environment surrounding the vehicle, an internal environment of the vehicle, and/or vehicle parameter data, the on-road sound may be tailored to the current situation and operating condition of the vehicle to improve safety of the vehicle occupants, pedestrians in the vicinity of the vehicle, and occupants of other vehicles in the vicinity of the vehicle in question.

In some situations, the operator may not select or provide a preferred sound file, in which case the on-road sound may be generated from a stock sound file and altered based on some or all of the remaining considerations. Regardless of whether the operator has indicated a preferred sound file, the disclosed systems and methods still improve the safety of all parties involved by tailoring the generated on-road sound production for the current situation and environment of the vehicle. In an exemplary implementation, sound intensity, sound pitch, or the like of the on-road sound production may be determined or modified based on determined characteristics of the operator of the vehicle; the presence of, number of, or characteristics of pedestrians in the vicinity of the vehicle; and/or the presence of, number of, or characteristics of other vehicles in the vicinity of the vehicle.

By tailoring the external on-road sound production based on the external environment and/or operating condition of the vehicle, the vehicle can produce more road noise or road noise more likely to alert other vehicles or pedestrians based on characteristics of the other vehicles or pedestrians, changing circumstances, and/or the environment encountered by the vehicle. The tailored on-road sound production also provides information to the other vehicles or pedestrians with respect to the speed of the vehicle in question and whether the vehicle is currently or about to accelerate or engine break by mimicking how an internal combustion engine sounds when operating under similar conditions.

Furthermore, by tailoring the internal or cabin on-road sound production based on the current internal environment and/or operating condition of the vehicle, the vehicle can increase or decrease the volume and pitch of the internal on-road sound to account for ambient noise level and conditions of the cabin of the vehicle. For example, lower frequency on-road sound may be more easily noticed than higher frequency sound if there is a crying baby in the cabin of the vehicle. In several instances, tailoring the internal on-road sound production based on characteristics of the operator may tailor the pitch of the internal on-road sound production to frequency bands more easily noticed by the operator, such as an operator with some degree of hearing loss. The tailored the internal on-road sound may also provide feedback to the operator indicating the operating condition of the vehicle, whether the vehicle will accelerate as the operator desires or expects, whether the vehicle is engine breaking or the degree of engine breaking, or the like.

To achieve the foregoing and other objects and advantages, in one aspect, the present subject matter is directed to a system for customization of on-road sound production for a vehicle. The system includes one or more noise generators supported relative to the vehicle and configured to produce a soundscape in an environment of the vehicle. The system further includes at least one memory storing instructions that, when executed by one or more processors, cause the processor(s) to generate the soundscape from one or more sound files also stored in the at least one memory based on an indication of a user-preferred sound file of two or more sounds files stored in the at least one memory, an environmental context surrounding the vehicle, or both. The instructions, when executed by the processor(s), cause the processor(s) to determine whether an operational status of the vehicle is suitable for on-road operation. The instructions, when executed by the processor(s), cause the processor(s) to further produce, in response to a determination that the operational status of the vehicle is suitable for on-road operation, the soundscape utilizing the noise generator(s) while the operational status of the vehicle is suitable for on-road operation.

In at least one embodiment, the generated soundscape may be an external soundscape, and the noise generator(s) may include an external speaker configured to produce the external soundscape in an external environment surrounding the vehicle. In some such embodiments or alternative embodiments, the sound intensity of the external soundscape may exceed a minimum regulator requirement by a determined amount. Additionally or alternatively, the generated soundscape may be an internal soundscape, and the noise generator(s) may include an internal noise generator configured to produce the internal soundscape in an internal environment of the vehicle. In some such embodiments, the noise generator(s) may include a cabin speaker configured to produce the internal soundscape in a cabin of the vehicle. In an additional or alternative embodiment, the instructions, when executed by the processor(s), may cause the processor(s) to generate the external soundscape from the sound file(s) also stored in the at least one memory based on an indication of a user-preferred external sound file of the sound files stored in the at least one memory, the environmental context surrounding the vehicle, or both. In an additional or alternative embodiment, the instructions, when executed by the processor(s), may cause the processor(s) to produce, in response to the determination that the operational status of the vehicle is suitable for on-road operation, the external soundscape utilizing the exterior speaker while the operational status of the vehicle is suitable for on-road operation. Additionally or alternatively, the instructions, when executed by the processor(s), may cause the processor(s) to modify or determine a relative balance of a sound intensity of the external soundscape and a sound intensity of the internal soundscape based the environmental context surrounding the vehicle, an environmental context of the internal environment of the vehicle, or both.

In an additional or alternative embodiment, the soundscape may be generated from one or more of a user-selected or a user-provided sound file of the sound files. Additionally or alternatively, the system may further include one or more external environmental sensors supported relative to the vehicle. In some such embodiments or differently configured embodiments, the instructions, when executed by the processor(s), may cause the processor(s) to receive data communicated from external environmental sensor(s) and indicating the environmental context surrounding the vehicle. Additionally or alternatively, the soundscape may be generated utilizing an artificial intelligence algorithm and further based on the data communicated from the external environmental sensor(s). In additional or alternative embodiments, generating the soundscape based on the environmental context surrounding the vehicle may include modifying one or more of a sound intensity or a pitch of the soundscape based on the environmental context surrounding the vehicle. Additionally or alternatively, the sound intensity may be modified based, at least in part, on a proximity of a pedestrian relative to the vehicle. Additionally or alternatively, the soundscape may be further generated based, at least in part, on an available energy level of the vehicle.

In an additional or alternative embodiment, the instructions, when executed by the processor(s), may cause the processor(s) to identify an occupant profile associated with an occupant of the vehicle. Additionally or alternatively, the occupant profile may indicate a desired sound intensity of the soundscape different than one or more of a stock sound intensity or an additional desired sound intensity indicated by an additional occupant profile. In some such embodiment or different embodiments, the system may further include one or more internal environmental sensor supported relative to the vehicle. Additionally or alternatively, the instructions, when executed by the processor(s), may cause the processor(s) to receive data communicated from the internal environmental sensor(s) and indicating one or more characteristics of an occupant of the vehicle. In an additional or alternative embodiment, the soundscape may be generated utilizing an artificial intelligence algorithm and further based on the data indicating the characteristic(s) of the occupant.

In an additional or alternative aspect, the present subject matter is directed to a non-transitory computer-readable medium comprising instructions stored in at least one memory that, when executed by one or more processors, cause the one or more processors to carry out steps. The steps include receiving data communicated from one or more external vehicle environmental sensors and indicating an environmental context surrounding a vehicle. The steps further include generating a soundscape from one or more sound files also stored in the at least one memory based on the received data indicating the environmental context surrounding the vehicle. The steps also include determining whether an operational status of the vehicle is suitable for on-road operation. The steps additionally include producing, in response to a determination that the operational status of the vehicle is suitable for on-road operation, the soundscape utilizing one or more noise generators supported relative to the vehicle while the operational status of the vehicle is suitable for on-road operation.

In at least one embodiment, the generated soundscape may be an external soundscape. Additionally or alternatively, the noise generator(s) may include an external speaker configured to produce the external soundscape in an external environment surrounding the vehicle. In some such embodiments or different embodiments, the generated soundscape may be an internal soundscape. Furthermore or alternatively, the noise generator(s) may include an internal noise generator configured to produce the internal soundscape in an internal environment of the vehicle. In an additional or alternative embodiment, the soundscape may be generated utilizing an artificial intelligence algorithm. Additionally or alternatively, generating the soundscape based on the environmental context surrounding the vehicle may include modifying a sound intensity of the soundscape based on the environmental context surrounding the vehicle.

In an additional or alternative aspect, the present subject matter is directed to a non-transitory computer-readable medium comprising instructions stored in at least one memory that, when executed by one or more processors, cause the one or more processors to carry out steps. The steps include receiving an indication of a user-preferred sound file of two or more sounds files also stored in the at least one memory. The steps further include generating a soundscape from the sound file(s) also stored in the at least one memory based on the indication of the user-preferred sound file. The steps also include determining whether an operational status of the vehicle is suitable for on-road operation. The steps additionally include producing, in response to a determination that the operational status of the vehicle is suitable for on-road operation, the soundscape utilizing one or more noise generators supported relative to the vehicle while the operational status of the vehicle is suitable for on-road operation.

In at least one embodiment, the indication of the user-preferred sound file may include one or more of a user-selected or a user-provided sound file of the sound files. Additionally or alternatively, the steps may further include receiving data communicated from one or more internal environmental sensors and indicating one or more characteristics of an occupant of the vehicle. In an additional or alternative embodiment, the soundscape may be generated utilizing an artificial intelligence algorithm and further based on the data indicating the characteristic(s) of the occupant.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a system for customization of on-road sound production for a vehicle, in accordance with aspects of the present subject matter;

FIG. 2 illustrates a schematic diagram of an exemplary embodiment of a vehicle including or suitable for use with a system for customization of on-road sound production, in accordance with aspects of the present subject matter;

FIG. 3 illustrates a schematic logic diagram of an exemplary embodiment of a system for customization of on-road sound production for a vehicle, in accordance with aspects of the present subject matter;

FIG. 4A illustrates an exemplary embodiment of a method including method elements, one or more of which may be implemented in a method for customization of on-road sound production for a vehicle, in accordance with aspects of the present subject matter;

FIG. 4B illustrates an exemplary embodiment of a method including additional or alternative method elements, one or more of which may be implemented in a method for customization of on-road sound production for a vehicle, in accordance with aspects of the present subject matter;

FIG. 4C illustrates an exemplary embodiment of a method including additional or alternative method elements, one or more of which may be implemented in a method for customization of on-road sound production for a vehicle, in accordance with aspects of the present subject matter;

FIG. 5 illustrates a schematic diagram of an exemplary embodiment of a network of a cloud-based system for implementing various cloud-based services, in accordance with aspects of the present subject matter;

FIG. 6 illustrates a schematic diagram of an exemplary embodiment of a server which may be used in the cloud-based system of FIG. 5 or stand-alone, in accordance with aspects of the present subject matter; and

FIG. 7 illustrates a schematic diagram of an exemplary embodiment of a user device which may be used in the cloud-based system of FIG. 5 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate customization of on-road sound production for a vehicle by allowing an occupant to select a preferred sound file or provide the preferred sound file for generation of internal and/or external on-road sound. The generated on-road sound is intended to supplement noise generated by a quiet internal combustion engine, electric engine, or hybrid engine of the vehicle in question. The on-road sound may be generated based on the preferred sound file of the occupant, an environment surrounding the vehicle, an internal environment of the vehicle, vehicle parameter data, or a combination of the above. Thus, operators are permitted to select or provide the source sound files utilized to generate the external or internal on-road sounds, respectively. Based on the environment surrounding the vehicle, an internal environment of the vehicle, and/or vehicle parameter data, the on-road sound may be tailored to the current situation and operating condition of the vehicle to improve safety of the vehicle occupants, pedestrians in the vicinity of the vehicle, and occupants of other vehicles in the vicinity of the vehicle in question.

In some situations, the operator may not select or provide a preferred sound file, in which case the on-road sound may be generated from a stock sound file and altered based on some or all of the remaining considerations. Regardless of whether the operator has indicated a preferred sound file, the disclosed systems and methods still improve the safety of all parties involved by tailoring the generated on-road sound production for the current situation and environment of the vehicle. In an exemplary implementation, sound intensity, sound pitch, or the like of the on-road sound production may be determined or modified based on determined characteristics of the operator of the vehicle; the presence of, number of, or characteristics of pedestrians in the vicinity of the vehicle; and/or the presence of, number of, or characteristics of other vehicles in the vicinity of the vehicle.

By tailoring the external on-road sound production based on the external environment and/or operating condition of the vehicle, the vehicle can produce more road noise or road noise more likely to alert other vehicles or pedestrians based on characteristics of the other vehicles or pedestrians, changing circumstances, and/or the environment encountered by the vehicle. The tailored on-road sound production also provides information to the other vehicles or pedestrians with respect to the speed of the vehicle in question and whether the vehicle is currently or about to accelerate or engine break by mimicking how an internal combustion sounds when operating under similar conditions.

Furthermore, by tailoring the internal or cabin on-road sound production based on the current internal environment and/or operating condition of the vehicle, the vehicle can increase or decrease the volume and pitch of the internal on-road sound to account for ambient noise level and conditions of the cabin of the vehicle. For example, lower frequency on-road sound may be more easily noticed than higher frequency sound if there is a crying baby in the cabin of the vehicle. In several instances, tailoring the internal on-road sound production based on characteristics of the operator may tailor the pitch of the internal on-road sound production to frequency bands more easily noticed by the operator, such as an operator with some degree of hearing loss. The tailored the internal on-road sound may also provide feedback to the operator indicating the operating condition of the vehicle, whether the vehicle will accelerate as the operator desires or expects, whether the vehicle is engine breaking or the degree of engine breaking, or the like.

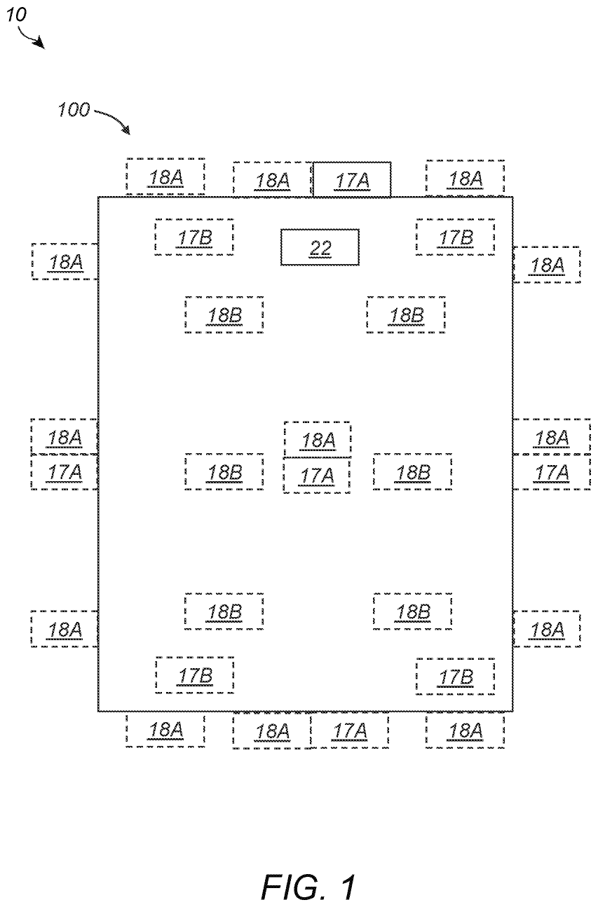

Referring now generally to FIG. 1, a schematic diagram of an exemplary embodiment of a system for customization of on-road sound production for a vehicle is illustrated in accordance with aspects of the present subject matter. As shown, a vehicle 10 may generally include a system 100 for customizing, controlling, and/or managing the operation of one or more components of the vehicle 10 utilized to or in association with producing on-road sound for quiet or nearly noiseless vehicles, such as electric vehicles, as will be explained in more detail in the following description. As depicted, the vehicle 10 and/or system 100 generally includes one more noise generators 17 supported relative to the vehicle 10 and configured to produce a soundscape in an environment of the vehicle 10. For example, the soundscape may generally include on-road sound produced to mimic, replace, or supplement engine noises typically produced by a traditional vehicle including an internal combustion engine (ICE) in use. In one instance, the soundscape includes, mimics, replaces, or supplements an engine roar noise that typically results from heavy acceleration of a traditional ICE vehicle.

The noise generator(s) 17 may generally include one or more speakers, horns, buzzers, bells, sirens, mechanical noise makers, electrical/magnetic noise makers, or the like suitable to generate sounds (e.g., an external soundscape) in an external environment surrounding the vehicle 10 and/or to generate sounds (e.g., an internal soundscape) in an internal environment (e.g., cabin, operator compartment, or the like) of the vehicle 10. Furthermore, the noise generator(s) 17 may include one or more external noise generators 17A, one or more internal noise generators 17B, or both. In the depicted embodiment, the system 100 and/or vehicle 10 includes multiple of each of the external noise generators 17A and internal noise generators 17B. However, various configurations of vehicles include additional, fewer, or alternatively placed noise generators 17.

FIG. 1 illustrates numerous noise generators 17 in phantom signifying that the position and number of such noise generators 17 may be different between different vehicles, trim packages of the same vehicle, etc. Regardless, the system 100 and/or vehicle 10 includes at least one noise generator 17. For instance and as depicted in FIG. 1, the vehicle 10 and/or system 100 includes the external noise generator 17A depicted in solid lines and positioned near a front, grill, hood, etc. of the vehicle 10. However, it should be appreciated that in additional or alternative embodiments of the vehicle 10 and/or system 100 the at least one noise generator 17 may be alternatively positioned, e.g., such as an external noise generator 17A supported or coupled to a roof of the vehicle, e.g., an omni-directional external noise generator 17A. In other or further configurations, the at least one noise generator 17 may include an internal noise generator 17B, e.g., an internal noise generator 17B positioned within the cabin of the vehicle 10 and/or near the operator seat or within an operator compartment of a suitably configured vehicle 10. In one instance, the noise generator(s) 17 includes one or more cabin speakers, such as a cabin speaker associated with the operator seat, compartment, etc. of the vehicle 10, such as all of the cabin speakers of the vehicle 10.

As further illustrated in FIG. 1, the vehicle 10 and/or system 100 optionally includes one or more environmental sensors 18, such as external environmental sensor(s) 18A and/or internal environmental sensor(s) 18B, each depicted in phantom. In the depicted embodiment, the system 100 and/or vehicle 10 includes multiple of each of the external environmental sensors 18A and the internal environmental sensors 18B. However, various configurations of vehicles include additional, fewer, or alternatively placed environmental sensors 18. In some embodiments, the vehicle 10 and/or system 100 may not include any environmental sensors 18. Additionally or alternatively, the vehicle 10 may include one or more environmental sensors 18 that are not utilized by the system 100, as disclosed herein. The environmental sensor(s) 18 may include on or more of a camera, a LiDAR sensor, a radar sensor, a microphone, a proximity sensor, an impact sensor, an infrared sensor, an acoustic sensor, an optical sensor, a seat sensor, a sensor suitable to transmit and/or receive suitable electromagnetic signals/waves, and/or the like. In one instance and when included in the system 100, the external environmental sensor(s) 18A may include one or more of a camera, a LiDAR sensor, a radar sensor, a microphone, a proximity sensor, an impact sensor, an infrared sensor, an acoustic sensor, or an optical sensor. Additionally or alternatively and when included in the system 100, the internal environmental sensor(s) 18B may include a cabin sensor.

The vehicle 10 and/or system 100 includes one or more memory devices storing instructions that, when executed by one or more processors, cause the processor(s) to carry out one or more logical steps or method elements for customization of on-road sound production for a vehicle, as described in more detail below. In some embodiments and as shown, the vehicle 10 and/or system 100 may further include a control unit 22 (e.g., an electronic control unit, multiple associated control units, and/or a combination of one or more processing devices and at least one memory or memory device as described herein) communicatively coupled to one or more of the noise generator(s) 17, the environmental sensor(s) 18, one or more mobile device of the occupant(s), and/or other components of the vehicle 10 and/or system 100, such as an optional audio control system, amplifier, preamplifier, or the like, described in more detail in the following description. The control unit 22 may be configured to direct operation of one or more of such components in accordance with aspects of the present subject matter.

While a single control unit 22 is illustrated in FIG. 1 for simplicity, it should be appreciated that the control unit 22 may include multiple associated control units, electronic control units, processing devices, memory devices, or the like that together are configured to provide operational control of the vehicle 10, the system 100, the noise generator(s) 17, the environmental sensor(s) 18, and/or other components of the vehicle 10 and/or system 100. The control unit 22 may additionally or alternatively facilitate communication between the vehicle 10, the system 100, the noise generator(s) 17, the environmental sensor(s) 18, the external environment of the vehicle 10, the internal or cabin environment of the vehicle 10, and/or internal screens, touchscreens, displays, or the like of the vehicle 10 (omitted from FIG. 1).

Generally, the control unit 22 may be preloaded with one or more sound files suitable to generate a soundscape for the vehicle 10 and/or may be configured to receive a signal or data indicative of a sound file(s) suitable to generate a soundscape for the vehicle 10, the environmental context surrounding the vehicle 10, the environmental context of the cabin of the vehicle 10, and/or characteristics or parameters (vehicle parameters) of one or more components or systems included in or associated with the vehicle 10, e.g., engine parameters, geographical location, power supply information, maintenance information, faults or errors, vehicle speed, etc.

In operation, the control unit 22 generally determines whether the operational status of the vehicle is suitable for on-road operation, e.g., an “on” status of the vehicle 10, an associated power source, or the like. Generally, an operational status of the vehicle suitable for on-road operation includes operation of any included ICE or an equivalent operational condition of an electric vehicle that would be associated with operation of an ICE of a traditional vehicle. It should be appreciated that the current disclosure is particularly relevant to producing soundscapes in any situation where a similarly situated ICE vehicle would produce at least some or more engine noise than the configuration of the vehicle 10. In other words, if the vehicle 10 can be placed in the Drive (D) gear and move under its own power in response to any accelerator input, without more, the operational status of the vehicle is suitable for on-road operation.

The control unit 22 also generally generates the soundscape (e.g., a single soundscape, an internal soundscape, and/or an external soundscape) and/or determines characteristics of the soundscape based on an indication of user-preferred sound file(s) for the soundscape(s), the environmental context surrounding the vehicle 10, the environmental context of the cabin of the vehicle 10, and/or vehicle parameters of the vehicle 10, as described in more detail herein. The control unit 22 further causes the soundscape(s) to be generated in response to determining that the operational status of the vehicle is suitable for on-road operation, e.g., either directly or through operational control of an associated audio control system. Furthermore, the control unit 22 may include or utilize one or more artificial intelligence programs to determine one or more sound files to utilize to generate the soundscape(s), to generate the soundscape(s), and/or to determine or modify one or more characteristics of the soundscape(s) based on the data or signals communicated to the control unit 22.

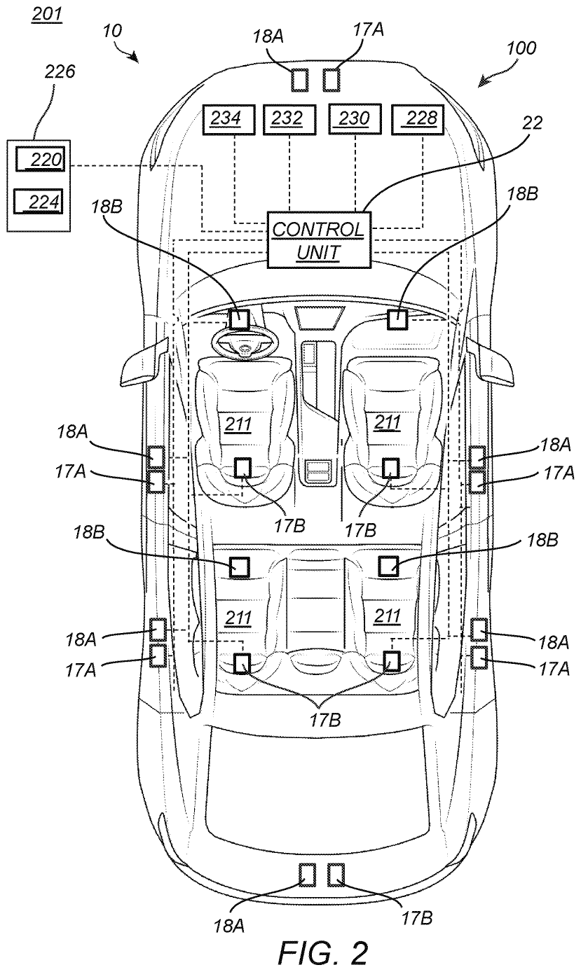

Referring now to FIG. 2, a schematic diagram of an exemplary embodiment of a vehicle including or suitable for use with a system for customization of on-road sound production is illustrated in accordance with aspects of the present subject matter. As shown, the vehicle 10 may generally include the system 100 for customization of on-road sound production and/or components thereof, as described herein.

While the exemplary illustration of FIG. 2 shows an empty vehicle 10 (e.g., without an occupant such as an operator, passenger, child, pet, etc.), embodiments of the system 100 disclosed herein may be particularly useful in situations where the vehicle 10 is operated by an operator. However, the subject matter is equally applicable to a driverless vehicles without an operator present (e.g., autonomous vehicles), especially with respect to the production of external soundscapes.

As shown, the vehicle 10 generally includes a plurality of seats, seat assemblies, occupant suites, or the like (seat assemblies 211 of FIG. 2). As further illustrated, the vehicle 10 and/or system 100 may include one or more noise generators 17, environmental sensors 18, and control unit 22 as described above with respect to FIG. 1. The number, position, and orientation of such components are illustrated in FIG. 2 to provide an example, and it should be appreciated that alternative embodiments of the vehicle 10 may include fewer, additional, or alternatively configured components so long as such components are suitable to implement the logical steps and/or method elements disclosed herein. While each seat assembly 211 of FIG. 2 is illustrated with one or more associated or dedicated internal noise generators 17B and internal environmental sensors 18B, some vehicles 10 and/or systems 100 may not include an internal environmental sensor 18B for each seat assembly 211. For example, only a portion of the seat assemblies 211 may be provided with a dedicated cabin microphone, camera, or the like, such as some but not all of the rear seat assemblies 211.

Furthermore, other embodiments of the vehicle 10 and/or system 100 may include or be associated with more, fewer, or differently positioned/oriented external noise generators 17A and/or external environmental sensors 18A. For example, some embodiments may include a single bird's-eye-view camera, a single microphone, and/or single external speaker at a central location (e.g., the roof of the vehicle 10), omitted from FIG. 1 for clarity. The operator seat 211, operator compartment, or the like may be provided with one more associated internal environmental sensors 18B or internal noise generators 17B in several embodiments. Alternatively or additionally, doors of the vehicle 10 adjacent to one another may share one or more external noise generators 17A and/or external environmental sensors 18A or even lack either or both of these components. Furthermore or alternatively, the one or more corners of the vehicle 10 may be provided with dedicated external noise generators 17A and/or external environmental sensors 18A. Furthermore, some embodiments of the vehicle 10 and/or system 100 may not include the front external noise generator 17A, the front external environmental sensor 18A, the rear external noise generator 17A, and/or the rear external environmental sensor 18A.

Optionally and as depicted in FIG. 2, at least some of the occupants seated within the vehicle 10, such as each occupied seat assembly 211 or at least the operator of the vehicle 10 may be associated with a mobile device 220 (e.g., a cellular phone, tablet, laptop, MP4/MP3 audio device, smart watch, smart glasses, wearable technology, or the like). Thus and in some embodiments, the internal environmental sensor(s) 18B may include one more receivers/transceivers suitable to establish a wired or wireless connection (e.g., a near-field connection, a local area network connection, a Wi-Fi connection, a Bluetooth connection, or the like) between the vehicle 10, the system 100, and/or an associated control unit 22 and the mobile device(s) 220 of the occupant(s).

In some embodiments, the vehicle 10 may be an electric vehicle having electrical components (e.g., one or more electric motors, associated batteries, etc.) for propelling the vehicle 10. Additionally or alternatively, the vehicle 10 may be configured with a rear-mounted or front-mounted ICE. In other embodiments, the vehicle 10 may be configured as a hybrid vehicle, which is driven by both a petroleum product (e.g., gas, diesel, jet fuel, and the like) and electrical power. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. Similarly, the vehicle 10 may have any other suitable number and position of doors, external noise generators 17A, internal noise generators 17B, external environmental sensors 18A, internal environmental sensors 18B, and the like. Additionally or alternatively, in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, boats, busses, passenger rail cars, and the like) where production or supplementation of on-road sound is desired or required. Thus, regardless of the type of power train, design, or model of the vehicle 10, the vehicle 10 may include or be utilized with embodiments of the system 100, as described herein.

As shown, the vehicle and/or system 100 may further include the control unit 22 (e.g., an electronic control unit, multiple associated control units, and/or a combination of one or more processing devices and at least one memory or memory device as described herein) communicatively coupled to the noise generator(s) 17, the environmental sensor(s) 18, the mobile device(s) 220 of the occupant(s), and/or other components of the vehicle 10 and/or system 100. The control unit 22 may be configured to direct operation of one or more of such components in accordance with aspects of the present subject matter. While a single control unit 22 is illustrated in FIG. 2 for simplicity, it should be appreciated that the control unit 22 may include multiple associated control units that together are configured to provide operational control of the vehicle 10, the system 100, the noise generator(s) 17, the environmental sensor(s) 18, the mobile device(s) 220 of the occupant(s), and/or other components of the vehicle 10 and/or system 100, such as an audio control system and/or internal screens, touchscreens, displays, or the like of the vehicle 10.

Generally, the control unit 22 may be configured to receive a signal or data indicative of an environmental context surrounding the vehicle 10 or within an internal environment or cabin of the vehicle 10, such as an audio and/or visual environment, an indication of a user-preferred sound file, a user-provided sound file, and/or vehicle parameters. Based on such received signals or data, the control unit 22 may generally generate one or more soundscapes (e.g., internal and/or external) and/or modify characteristics of such soundscape(s) and cause production of the soundscape(s) when the operational status of the vehicle 10 is suitable for on-road operation. Furthermore and as shown in FIG. 2., the control unit 22 may receive vehicle parameters from various additional or alternative components of the vehicle 10 or components associated with the vehicle 10 to similarly provide operational control, feedback, or input information, as described in more detail below. Furthermore, the control unit 22 may include or be communicatively coupled with one or more external devices 226, such as a mobile device 220, a remote storage 224 (e.g., memory device, server, cloud system), or the like. In some embodiments, the external device(s) 226, the mobile device(s) 220, and/or a remote storage 224 may function as a repository of sound files or occupant profiles that may be provided or selectively provided to the system 100.

While some communication links in FIG. 2 may be illustrated as joint communication links, it should be appreciated that one or more components communicatively coupled to the control unit 22, such as all of the components, may have component dedicated communication links (e.g., wireless or wired communication links with the control unit 22).

By applying an appropriate algorithm in the control unit 22, the system 100 can be integrated with the rest of the vehicle systems, with input from/output to a vehicle power source 228 (e.g., one or more electric motors, ICE motors, or associated control systems, monitors, sensors, etc.), a vehicle power supply 230 (e.g., one or more batteries, gas tanks, or associated control systems, monitors, sensors, etc.), an infotainment unit or system (infotainment unit 232), an audio system 234 (e.g., one or more control systems, amplifiers, preamplifiers, or the like), the noise generator(s) 17, the environmental sensor(s) 18, the external device(s) 226, the mobile device(s) 220, and/or the remote storage 224. In several embodiments some of such devices, such as all of such devices, may each include or be associated with a mobile application and/or a cloud application configured to provide external information and/or instructions to the control unit 22.

In some embodiments, besides controlling the operation of the vehicle 10, system 100, and/or included or associated components thereof, the control unit 22 may also provide useful information to the operator via the mobile device(s) 220 and/or infotainment unit 232, such as a display or touch screen thereof. Associated user interface(s) may include one or more buttons, switches, touch screen capability, or the like allowing an operator of the vehicle 10 to communicate inputs to the control unit 22 utilized to control operation of the vehicle 10, system 100, and/or components or subsystems thereof.

With respect to the external environmental sensor(s) 18A, such sensors 18A may generally be configured to communicate one or more signals suitable for the control unit 22 to determine, without limitation, that a pedestrian, multiple pedestrians, an animal, multiple animals, another vehicle, and/or multiple other vehicles are within proximity of the vehicle 10; the relative position and orientation of the pedestrian(s), animal(s), and/or the other vehicle(s) relative to the vehicle 10; characteristics of the pedestrian(s), animal(s), and/or the other vehicle(s); an indication of the type of environment surrounding the vehicle (e.g., remote, urban, freeway, private property, parking lot, forest, planes, etc.); transitory conditions of the environment of the vehicle (e.g., weather, lighting conditions, wind direction, traffic density, etc.); an external ambient noise level; and/or characteristics of the external ambient noise (e.g., low-frequency or high-frequency audio environment).

With respect to the internal environmental sensor(s) 18B, such sensors 18B may generally be configured to communicate one or more signals suitable for the control unit 22 to determine, without limitation, characteristics of the occupant(s) of the vehicle 10, an internal or cabin ambient noise level, and/or characteristics of the internal or cabin ambient noise.

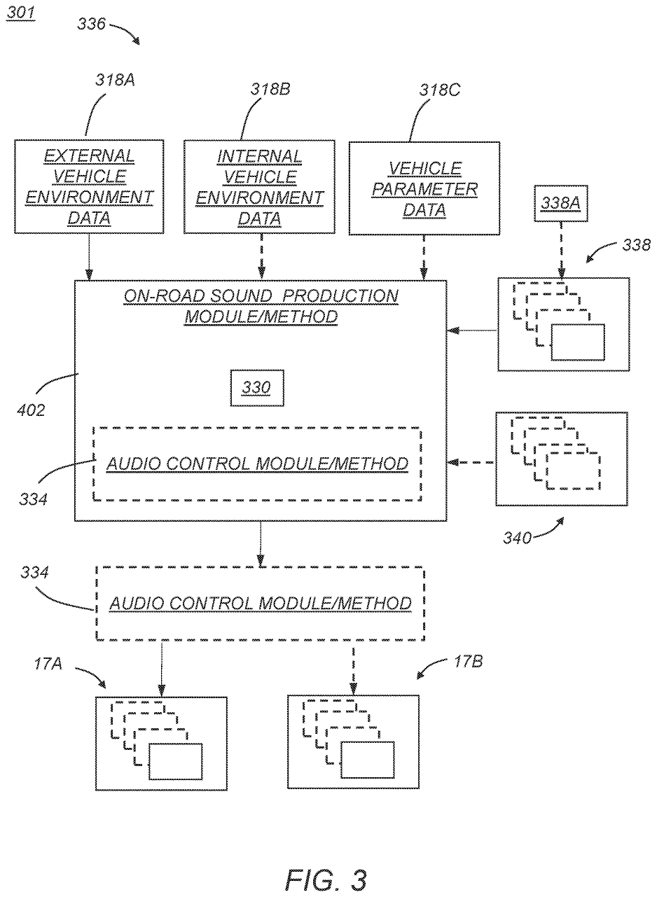

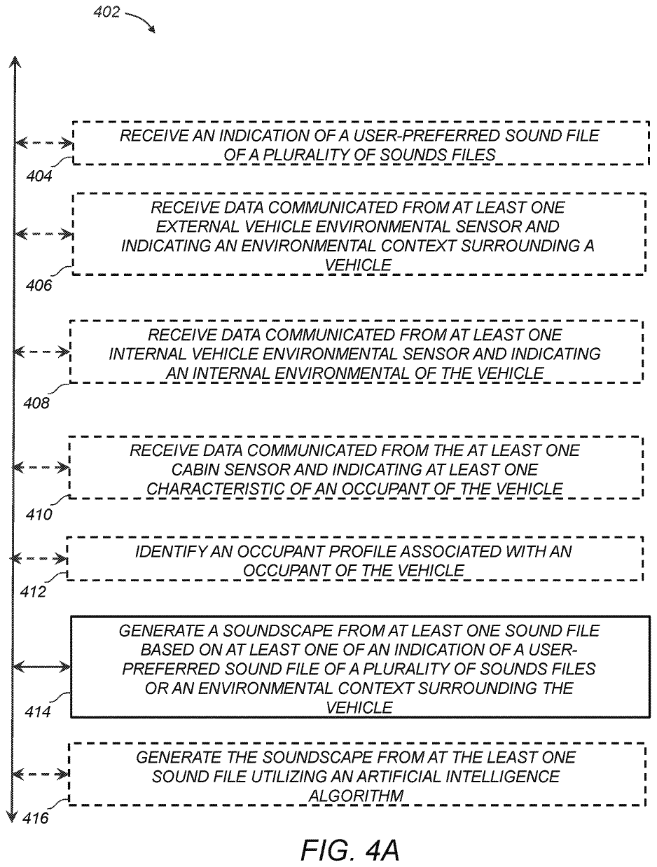

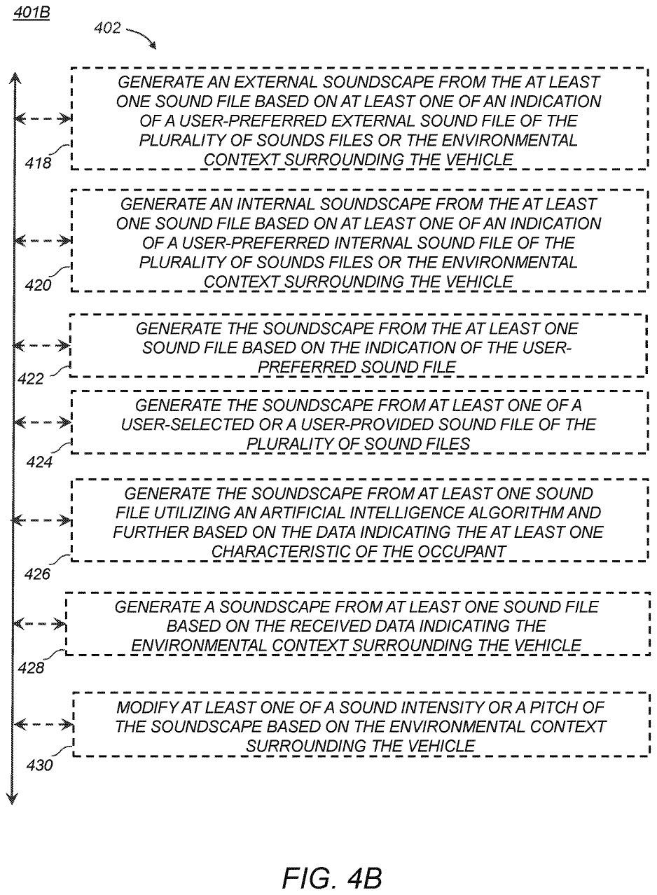

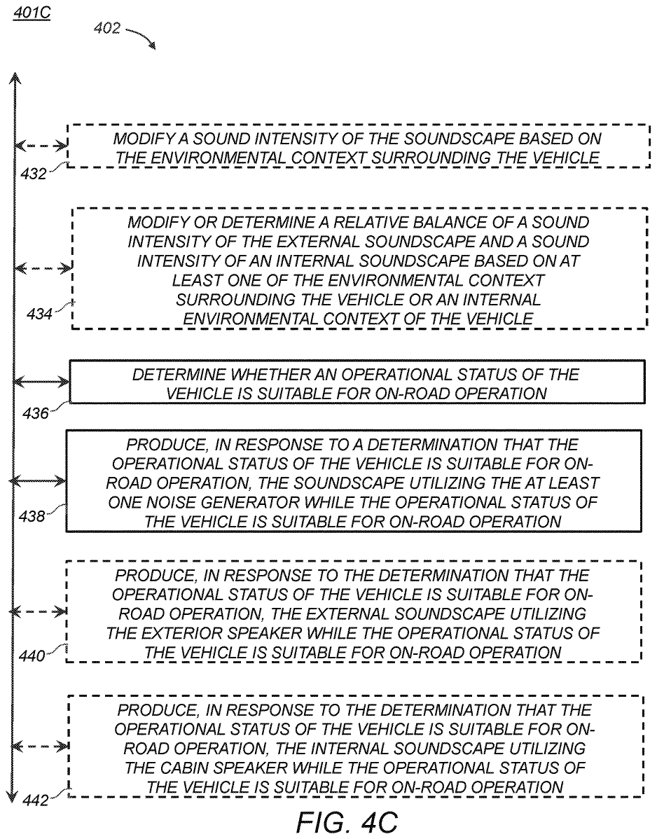

Referring now to FIGS. 3-4, FIG. 3 illustrates a schematic logic diagram of an exemplary embodiment of a system for customization of on-road sound production for a vehicle in accordance with aspects of the present subject matter; FIG. 4A illustrates method elements, one or more of which may be implemented in a method for customization of on-road sound production for a vehicle in accordance with aspects of the present subject matter; FIG. 4B illustrates additional or alternative method elements, one or more of which may be implemented in a method for customization of on-road sound production for a vehicle in accordance with aspects of the present subject matter; and FIG. 4C illustrates additional or alternative method elements, one or more of which may be implemented in a method for customization of on-road sound production for a vehicle in accordance with aspects of the present subject matter.

The logic diagram depicted in FIG. 3 (control logic 336) and/or the method or process (method 402) depicted in one or more of FIGS. 4A-4C may be utilized to control or in association with embodiments of the vehicle 10 and/or the system 100 as described above with respect to FIGS. 1-2, any of the components or subsystems thereof such as the noise generator(s) 17, the environmental sensor(s) 18, the control unit 22, the external device(s) 226, the mobile device(s) 220, the remote storage 224, vehicle power source(s) 228, the vehicle power supply(ies) 230, infotainment unit 232, an audio system 234 (if not already included or embedded within control unit 22), and/or other control systems or monitoring system of the vehicle 10, such as an electronic vehicle control system configured to provide general operational control of the vehicle 10. However, it should be appreciated that the control logic 336 and/or the method 402 may be utilized to control or in association with embodiments of other similar or suitably configured vehicles, systems for customization of on-road sound production for a vehicle, and/or components or subsystems thereof. The control logic 336 may include one or more modules including instructions stored in at least one memory and executable by one or more processors to cause the processor(s) to implement steps, method elements, or the like as described herein. For example, elements of the control logic 336 and/or method 402 may be implemented, at least in part, by the control unit 22 and stored in memory associated with the control unit 22 and/or included with or accessible by the vehicle 10.

As shown in FIG. 3, one or more sound files 338 are stored or accessible by the system or vehicle implementing the control logic 336 and/or method 402 (e.g., optionally stored and/or executed as an on-road sound production module 402 or multiple modules, sub-routines, or the like suitable to execute some or all of the elements of method 402). For example, the sound file(s) 338 may be stored in one or more memory devices of the vehicle 10, system 100, and/or control unit 22. The sound file(s) 338 may generally include data suitable to produce sound utilizing appropriate systems or components of the vehicle 10, e.g., the control unit 22, the audio system 234, and/or the noise generator(s) 17. For example, the sound file(s) 338 may include one or more of Motion Pictures Expert Group (MPEG) audio layer 3 (MP3) files or MPEG-4 Part 14 (MP4) files.

It should be appreciated that various embodiments of the method 402 and system 100 disclosed herein contemplate multiple sound files 338 stored locally at the vehicle 10. However, the disclosed system 100 and/or method 402 is equally applicable for customization of on-road sound production for a vehicle utilizing a single sound file 338. For example, the following disclosure describes how characteristics of the produced soundscape(s) may be determined or modified based on the environmental context surrounding the vehicle 10 (e.g., external vehicle environment data 318A received or sensed from any of the external environmental sensors 18A), the internal or cabin environment of the vehicle 10 (e.g., internal vehicle cabin data 318B received or sensed from any of the internal environmental sensors 18B), characteristics or parameters (vehicle parameters) of one or more components or systems included in or associated with the vehicle 10 (e.g., vehicle parameter data 318C), and/or information indicated from one or more occupant profiles 340 stored or accessible by the system 100 and/or vehicle 10.

As further shown in FIGS. 3 and 4A, the control logic 336 and/or method 402 may include receiving an indication of a user-preferred sound file of a plurality of sounds (method element 404). For example, the control logic 336 and/or method 402 may include receiving an indication of a user-preferred sound file 338 of a plurality of sounds files 338 also stored (or locally assessable) in the memory of the control unit 22. In some instances, the indication of the user-preferred sound file 338 includes a user-selected sound file 338 of the sound files 338 already stored in the memory of the control unit 22. Additionally or alternatively, the indication of the user-preferred sound file 338 includes user-provided sound file 338A of the sound files 338. The user-provided sound file 338A may be provided to the control unit 22 from the external device(s) 226, mobile device(s) 220, and/or remote storage 224 either directly or via identification of such file for retrieval. The sound file(s) 338 may include one or more sound files 338 that indicate sound that mimics the noise produced by an ICE engine, the noise produced by a big-block ICE engine, the noise produced by a diesel engine, the noise produced by a high-revving ICE engine, the noise produced by low-revving ICE engine, the noise produced by futuristic cars in television, movies, and the like, the noise produced by a motorcycle, and/or any other noise associated with the operational status of a vehicle suitable for on-road operation.

The control logic 336 and/or method 402 may additionally or alternatively include receiving data communicated from the least one external environmental sensor and indicating the environmental context surrounding the vehicle (method element 406). For example, external vehicle environmental data 318A may be communicated from one or more of external environmental sensor 18A and indicating the environmental context surrounding the vehicle 10, as described herein.

The control logic 336 and/or method 402 may additionally or alternatively include receiving data communicated from at least one internal environmental sensor and indicating at internal environment of the vehicle (method element 408). For example, internal vehicle environmental data 318B may be communicated from the internal environmental sensor(s) 18B and indicate the internal environment or cabin environment of the vehicle 10. Furthermore or alternatively, the internal environmental data 318B may be communicated from a cabin sensor and indicate one or more characteristics of an occupant, such as the operator, of the vehicle 10, see method element 410. The control logic 336 and/or method 402 may additionally or alternatively include receiving vehicle parameter data 318C communicated from one or more components or systems included in or associated with the vehicle 10 and/or system 100, e.g., engine parameters, geographical location, power supply information, maintenance information, faults or errors, vehicle speed, etc.

Additionally or alternatively, the control logic 336, the method 402 or parts or components thereof may generally be implemented utilizing one or more artificial intelligence algorithms (AI algorithm(s) 330). For example, determining characteristics of an occupant of the vehicle 10, identifying an occupant profile 340 associated with an occupant, determining characteristics of the external environment surrounding the vehicle, determining characteristics of the internal or cabin environment of the vehicle 10, and generating and/or modifying the soundscape(s) based on some or all of such information may be performed utilizing the artificial intelligence algorithm(s) 330.

The AI algorithm(s) 330 may include one or more algorithms, programs, modules, and the like suitable to simulate intelligence human behavior or perform tasks historically requiring human implementation. For example, the AI algorithm(s) 330 may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the AI algorithm(s) 330 described herein may be trained (via a supervised or unsupervised training process) based on training data provided to the AI algorithm(s) 330.

For instance, several embodiments of the AI algorithm(s) 330 are operable for using external environmental inputs, internal environmental inputs, and/or vehicle parameter inputs to make soundscape and/or sound file 340 suggestions, adjust volume levels, pitch levels, etc., and/or adjust the internal/external balance of such characteristics between the internal and external soundscapes in an automated manner based on the observed environmental context. In one optional configuration, the AI algorithm(s) 330 utilizes a neural network (NN), such as a convolutional neural network (CNN), that is trained to segment and annotate images and/or identify sounds based on experiential learning.

As a further example, sound intensity, sound pitch, balancing, volume control, etc. may be provided on a proportional basis based on observed interior/external volume and/or identified sounds. The AI algorithm(s) 330 may utilize computer vision (CV), computer hearing (CH), and/or deep learning (DL) algorithms applied to the obtained images and/or sounds to enables both object and scenario detection, as well as road condition detection—is the scene urban, rural, a highway, a country road, a mountain, a seashore, a bridge; is the road clear, wet, slippery, is there an accident or an emergency vehicle; etc.? Such process may further enable both interior and external situational awareness—is the driver sleepy, excited, conversing, on the phone; is the vehicle noisy; is there an accident or emergency vehicle; etc.? Thus, the external noise generator(s) 17A and/or the internal noise generator(s) 17B and associated software implement machine learning (ML) and algorithms to audio and/or video signals to alter or change the sound file 338 utilized to generate the soundscape(s) and/or alter a volume or pitch of the generated soundscape(s) responsive to certain conditions or characteristics of the external environment of the vehicle, the external environment of the vehicle, and/or the vehicle parameters, as described herein. The present disclosure is agnostic related to these AI methodologies, and any suitable AI methodologies may be utilized equally.

The control logic 336 and/or method 402 may additionally or alternatively include identifying an occupant profile associated with an occupant of the vehicle (method element 412). For example, the internal environmental data 318B may indicate one or more characteristics of an occupant of the vehicle and may be utilized to identify an occupant profile 340 associated with the occupant in questions. In several instances, the AI algorithm(s) 330 may be utilized to identify an occupant profile 340 of multiple occupant profiles 340 stored at or accessible by the vehicle 10 and/or system 100 based on the internal vehicle environment data 318B.

Referring still to FIGS. 3 and 4A, the control logic 336 and/or method 402 may additionally or alternatively include generating the soundscape based on at least one of an indication of a user-preferred sound file of a plurality of sounds files or an environmental context surrounding the vehicle (method element 414). In one instance, the soundscape(s) are generating from the sound file(s) 338 also stored in memory local to or accessible by the control unit 22 based on an indication of a user-preferred sound file 338 of multiple sounds files 338 and/or an environmental context surrounding the vehicle 10. In several instances, the generated soundscape(s) may include an internal soundscape (method element 420 of FIG. 4B), an external soundscape (method element 418 of FIG. 4B), or both. The generated soundscape(s) may generally mimic the noises produced or associated with an ICE. Generally, the external noise generator(s) 17A may be configured to produce the external soundscape, and/or the internal noise generator(s) 17B may be configured to produce the internal soundscape. In several embodiments, the control logic 336 and/or method 402 may additionally or alternatively include generating the soundscape(s) utilizing an artificial intelligence program (method element 416).

In several embodiments, the sound intensity of the external soundscape may exceed a minimum regulatory requirement by a determined amount. For example, the determined amount may be a predetermined amount. In some instance, the predetermined amount may be a stock predetermined amount. Additionally or alternatively, the predetermined amount may be indicated by the occupant profile 340 associated with the occupant of the vehicle.

In several instances, the soundscape(s) are generated based, at least in part, on an identification of an occupant of the vehicle 10. For example, the occupant, such as the operator, of the vehicle 10 may be identified based on the internal vehicle environmental data 318B and/or utilizing an AI algorithm(s) 30, as described above. The occupant profile(s) 340 associated with the identified occupant(s) may generally indicate one or more of a previously selected or provided sound file 338 (indication of a user-preferred sound file), a desired sound intensity of the soundscape(s), a desired range of sound intensity of the soundscape(s), an average sound intensity of the soundscape(s), a minimum sound intensity of the soundscape(s), or a maximum sound intensity of the soundscape(s). Additionally or alternatively, the occupant profile(s) 340 associated with the identified occupant(s) may generally indicate one or more of a desired pitch of the soundscape(s), a desired pitch range of the soundscape(s), a desired average sound frequency of the soundscape(s), a desired minimum sound frequency of the soundscape(s), or a desired maximum sound frequency of the soundscape(s). In some further or alternative embodiments, the occupant profile(s) 340 associated with the identified occupant(s) may generally indicate a desired relative balance of the sound intensity of the external soundscape and the sound intensity of the internal soundscape. In several instances, the desired sound intensity of the soundscape(s) indicated by the occupant profile 340 of the identified occupant may be different than a stock sound intensity, an additional desired sound intensity indicated by an additional (different) occupant profile, or both.

Referring now to FIGS. 3 and 4B, the control logic 336 and/or method 402 may additionally or alternatively include generating the soundscape from the sound file(s) based on the indication of the user-preferred sound file (method element 422). In some instances, the external soundscape may be generated from the sound file(s) based on the indication of the user-preferred sound file or a user-preferred external sound file. Additionally or alternatively, the internal soundscape may be generated from the sound file(s) based on the indication of the user-preferred sound file or a user-preferred internal sound file. For instance, the soundscape(s) may be generated from the sound file(s) 338 stored in or accessible by the control unit 22 based on an indication of the user-preferred sound file 338. The indication of the user-preferred sound file may generally be indicated by the occupant profile 340 associated with the identified occupant and/or may be received via one or more of the interfaces of the vehicle 10 and/or system 100.

Additionally or alternatively, the control logic 336 and/or method 402 may include generating the soundscape from the sound file(s) based on the user-selected sound file 338, the user-provided sound file 338A, or both (method element 424). For example, the soundscape(s) may be generated from a user-selected sound file(s) 338 of the sound files 338. In an additional or alternative example, the soundscape(s) may be generated from the user-provided sound file 338A of sound files 338. It should be appreciated that the sound file 338 utilized for generation of the external soundscape may be different than the sound file 338 utilized for generation of the internal soundscape. For instance, the indication of the user-preferred sound file(s) 338 may indicate that a sound file 338 associated with a futuristic car sound is desired for the internal soundscape while a sound file 338 associated with a big-block ICE (e.g., hot rod, muscle car, etc.) sound is desired for the external soundscape.

In some further or different configured embodiments, the soundscape(s) may be generated based, at least in part, on data indicating one or more characteristics of the occupant. As illustrated, the control logic 336 and/or method 402 may include generating the soundscape from the sound files 338 utilizing an artificial intelligence algorithm and further based on the data indicating the characteristic(s) of the occupant (method element 426). For example, the soundscape(s) (e.g., internal, external, or both) may be generated utilizing the AI algorithm(s) 330 and based on the characteristic(s) of the occupant indicated by an occupant profile 340 associated with the occupant and/or the internal environmental vehicle data 318B. In some instances, the AI algorithm(s) 330 may be utilized to determine the characteristic(s) of the occupant based on the internal environmental vehicle data 318B and/or historical environmental vehicle data associated with the occupant and stored in association with the occupant profile 340 indicating the occupant.

In one example, the occupant may be determined to be a senior citizen, over a predetermined age (e.g., 55 years old), and/or that the occupant suffers from hearing loss. In response to such a determination(s), the control logic 336, the method 402, and/or the AI algorithm(s) 330 may be configured to generate the internal soundscape at an increased sound intensity compared to an initial or stock setting of the internal soundscape or associated sound file 338 or a sound intensity utilized in association with another occupant that does not have such characteristics (e.g., senior citizen, over the predetermined age, suffers from hearing loss, or the like). Additionally or alternatively and in response to such determination(s), the control logic 336, the method 402, and/or the AI algorithm(s) may be configured to generate the internal soundscape at lower pitch compared to an initial or stock setting of the internal soundscape or associated sound file 338 or a sound pitch utilized in association with another occupant that does not have such characteristics. For instance, a desired pitch of the internal soundscape, a desired pitch range of the internal soundscape, a desired average sound frequency of the internal soundscape, or a maximum sound frequency of the internal soundscapes may be lowered in response to such determination(s). It should be appreciated that the some, especially the elderly especially, struggle to hear higher frequencies noises compared to younger occupants, such as occupants under the age of 40, 30, 25, 20, etc. For example, some higher frequencies of sound are typically only heard by people under a certain age. Thus, the control logic 336, the method 402, and/or the AI algorithm(s) 330 may be configured to generate the internal soundscape at a lower pitch in response to the determination that the occupant is over a certain age or has hearing loss. Thus, the internal soundscape is tailored to the frequency band(s) more likely to be well heard by such occupants.

In some embodiments, the control logic 336 and/or method 402 may include generating the soundscape from the sound file(s) based on internal environment of the vehicle. For instance, the control unit 22 may receive the internal environmental vehicle data 318B and determine one or more characteristics of the internal or cabin environment of the vehicle 10. In one example, the sound file 338, the sound intensity of the internal soundscape, or pitch of the internal soundscape may be altered based on the determined characteristic(s) of the internal or cabin environment of the vehicle 10.

For instance, the internal sound intensity may be increased in response to a determination that the internal or cabin environment of the vehicle 10 is noisy or loud, such as a qualitative determination made by the AI algorithm(s) 330, or has an ambient internal sound intensity level over a predetermined threshold. Contrarily, the internal sound intensity may be decreased in response to a determination that the internal or cabin environment of the vehicle 10 is quiet, such as a qualitative determination made by the AI algorithm(s) 330, or has an ambient internal sound intensity level below a predetermined threshold. Additionally or alternatively, the sound pitch of the internal soundscape may be lowered in response to a determination that the internal or cabin environment of the vehicle 10 is a high-frequency environment (e.g., a high average sound frequency), such as a qualitative determination made by the AI algorithm(s) 330, or has an ambient internal sound frequency level above a predetermined threshold. For example, in a situation where the vehicle 10 is operated with a crying baby in the cabin, the internal soundscape may be generated or modified to have the lower sound pitch to distinguish the internal soundscape from the high-frequency internal/cabin environment. Similarly, the sound pitch of the internal soundscape may be raised in response to a determination that the internal or cabin environment of the vehicle 10 is a low-frequency environment (e.g., a low average sound frequency), such as a qualitative determination made by the AI algorithm(s) 330, or has an ambient sound frequency level below a predetermined threshold.

Referring still to FIGS. 3 and 4B, the control logic 336 and/or method 402 may include generating the soundscape from the sound file(s) based on the environmental context surrounding the vehicle (method element 428). Additionally or alternatively, the control logic 336 and/or method 402 may include modifying the sound intensity and/or the pitch of the soundscape based on the environmental context surrounding the vehicle (method element 430). A sound intensity of a soundscape (e.g., internal or external), as used herein, generally indicates one or more of an average sound intensity of the soundscape, a minimum sound intensity of the soundscape, a maximum sound intensity of the soundscape, and/or a range of sound intensity of the soundscape. A pitch of a soundscape (e.g., internal or external), as used herein, generally indicates one or more of an average frequency of the soundscape, minimum frequency of the soundscape, and/or frequency range or pitch range of the soundscape. In some embodiments, the sound intensity of the external soundscape may exceed the minimum regulatory amount by an amount determined based on the environmental context surrounding the vehicle 10 and/or the external environmental vehicle data 318A. Additionally or alternatively, determined amount may be generated utilizing an AI algorithm.

Generally and in some embodiments, the control unit 22 may receive the external environmental vehicle data 318A and determine one or more characteristics of the environment surrounding the vehicle 10. In some instances, the determined characteristics of the environment surrounding the vehicle 10 may include an external ambient noise level (e.g., average, minimum, maximum, and/or range of the external sound intensity of the external environment surrounding the vehicle 10) and/or an external ambient pitch level (e.g., average frequency, minimum frequency, and/or frequency or pitch range of the external environment surrounding the vehicle 10). In one example, the sound file 338, the sound intensity of the external soundscape, and/or pitch of the external soundscape may be altered based on the determined characteristic(s) of the external environment surrounding the vehicle 10. Additionally or alternatively, the sound file 338, the sound intensity of the internal soundscape, and/or pitch of the internal soundscape may be altered based on the determined characteristic(s) of the external environment surrounding the vehicle 10.

In some such embodiments and situations, the external environmental vehicle data 318A and/or determined geographical location of the vehicle may indicate that the vehicle is in an unregulated environment such as private property or other areas excluding state or government regulated roads. Additionally or alternatively, the AI algorithm(s) 330 may determine that the environmental context surrounding the vehicle 10 is an unregulated environment based, at least in part, on the external environmental vehicle data 318A. In such unregulated environments, the vehicle 10 may not be required to always meet or exceed the minimum regulatory requirement for sound intensity of the external soundscape. Thus, the control logic 336 and/or method 402 may additionally or alternatively include selectively reducing the sound intensity of the external soundscape below the minimum regulatory requirement in response to a determination that the environmental context surrounding the vehicle is an unregulated environment. Selectively, used in this context, may mean based on a setting of the vehicle 10, system 100, and/or occupant profile 340. Additionally or alternatively, selectively may mean in response to a real-time or concurrent selection of the operator of the vehicle 10 via a user interface associated with the vehicle 10 and/or system 100.

The amount the sound intensity is reduced below the minimum regulatory requirement may be a predetermined amount, determined based, at least in part, on the external environmental vehicle data 318A, and/or determined utilizing the AI algorithm(s) 330. Additionally, the control logic 336 and/or method 402 may include selectively reducing the sound intensity of the external soundscape below the minimum regulatory requirement in response to a determination that the environmental context surrounding the vehicle is a quiet environment, e.g., a drive-in movie theater, a campground at night, a private parking lot or driveway, or the like. In some embodiments, the quiet environmental context surrounding the vehicle may be determined based on the external environmental vehicle data 318A and/or utilizing the AI algorithm(s) 330.

It should be appreciated that altering and/or modifying the sound intensity of the soundscape(s) may include generating the soundscape(s) from a different sound file 338 already having the desired sound intensity or modifying the sound intensity during generation of the soundscape from the initial sound intensity associated with the pertinent sound file 338 and/or the initial sound intensity setting of the associated occupant profile 340. Similarly, altering and/or modifying the sound pitch of the soundscape(s) may include generating the soundscape(s) from a different sound file 338 already having the desired sound pitch or modifying the sound pitch during generation of the soundscape from the initial sound pitch associated with the pertinent sound file 338 and/or the initial sound pitch setting of the associated occupant profile 340.

Referring now to FIGS. 3 and 4C, the control logic 336 and/or method 402 may additionally or alternatively include modifying a sound intensity of the soundscape based on the environmental context surrounding the vehicle (method element 432). For instance, the external sound intensity may be increased in response to a determination that the external environment surrounding the vehicle 10 is noisy or loud, such as a qualitative determination made by the AI algorithm(s) 330, or has an ambient external sound intensity level over a predetermined threshold. Contrarily, the external sound intensity may be decreased in response to a determination that the external environment surrounding the vehicle 10 is quiet, such as a qualitative determination made by the AI algorithm(s) 330, or has an ambient external sound intensity level below a predetermined threshold. In various situations, the modification of the sound intensity of the external soundscape may be the result of a changing environmental context surrounding the vehicle 10.

Additionally or alternatively, the sound pitch of the external soundscape may be lowered in response to a determination the external environment surrounding the vehicle 10 is a high-frequency environment (e.g., a high average sound frequency), such as a qualitative determination made by the AI algorithm(s) 330, or has an ambient external sound frequency level above a predetermined threshold. Similarly, the sound pitch of the external soundscape may be raised in response to a determination that the external environment surrounding the vehicle 10 is a low-frequency environment (e.g., a low average sound frequency), such as a qualitative determination made by the AI algorithm(s) 330, or has an ambient external sound frequency level below a predetermined threshold. In various situations, the modification of the sound pitch of the external soundscape may be the result of a changing environmental context surrounding the vehicle 10.

In several instances, the sound file(s) 338 may indicate an initial sound intensity (stock sound intensity) and/or an initial sound pitch (stock sound pitch) of the associated soundscape(s) (internal, external, or both). Modifying the sound intensity of the soundscape(s) may include generating the soundscape(s) defining a modified sound intensity. Modifying the sound pitch of the soundscape(s) may include generating the soundscape(s) defining a modified sound pitch. Additionally or alternatively, the initial sound intensity and/or initial sound pitch of the associated soundscape(s) may be indicated by the occupant profile 340 associated with the occupant of the vehicle 10.

In some embodiments, modifying the sound intensity of the soundscape(s) may include altering the soundscape(s) from the initial state(s) defining the initial sound intensity(ies) of the soundscape(s) to a modified state(s) defining a modified sound intensity(ies). The modified sound intensity is generally different than the initial sound intensity. For example, the modified sound intensity may define a different average modified sound intensity, a different minimum modified sound intensity, a different maximum modified sound intensity, and/or a different range of sound intensity as compared to the initial sound intensity. In some embodiments, modifying the sound pitch of the soundscape(s) may include altering the soundscape(s) from the initial state(s) defining the initial sound pitch(es) of the soundscape(s) to a modified state(s) defining a modified sound pitch(es). The modified sound pitch is generally different than the initial sound pitch. For example, the modified sound pitch may define a different average modified frequency, a different minimum frequency, a different maximum frequency, and/or a different range of frequency or pitch as compared to the initial sound pitch.

Referring still to FIGS. 3 and 4C, the control logic 336 and/or method 402 may additionally or alternatively include modifying or determining a relative balance of a sound intensity of the external soundscape and a sound intensity of the internal soundscape based on at least one of the environmental context surrounding the vehicle or an internal environmental context of the vehicle (method element 434). For instance, the control unit 22 may determine the relative balance of the sound intensity of the external soundscape and the sound intensity of the internal soundscape based on the environmental context surrounding the vehicle, as indicated by the external vehicle environment data 318A. In an additionally or alternative example, the control unit 22 may determine the relative balance of the sound intensity of the external soundscape and the sound intensity of the internal soundscape based the internal environmental context of the vehicle, as indicated by the internal vehicle environment data 318B.

Furthermore, the control unit 22 may modify the relative balance of the sound intensity of the external soundscape and the sound intensity of the internal soundscape based on the environmental context surrounding the vehicle. Additionally or alternatively, the control unit 22 may modify the relative balance of the sound intensity of the external soundscape and the sound intensity of the internal soundscape based on the internal environmental context of the vehicle. In various situations, the modification of the relative balance of the sound intensity of the external soundscape and the sound intensity of the internal soundscape may be the result of a changing environmental context surrounding the vehicle 10 and/or the internal environmental context of the vehicle 10.

In some embodiments, the control logic 336 and/or method 402 may include modifying the soundscape(s) based, at least in part, on a proximity of a pedestrian relative to the vehicle 10. For example, the sound intensity of the external soundscape may be modified based on a proximity of a pedestrian relative to the vehicle 10 as indicated by the external vehicle environment data 318A. In various embodiments, the AI algorithm(s) 330 may identify one or more pedestrians within the external environment of the vehicle 10 and/or the position, orientation, or the like of the pedestrian(s) relative to the vehicle 10.

In one instance, the sound intensity of the external soundscape may be increased if the pedestrian is within a predetermined range of the vehicle 10. Such range may be a static number or variable based on the speed of the vehicle and road conditions. For instance, the predetermined range may result from a formula that utilizes the speed of the vehicle and an estimated friction of the road to determine a maximum range requiring increasing the sound intensity of the external soundscape. Alternatively, the AI algorithm(s) 330 may qualitatively determine the maximum range requiring increasing the sound intensity of the external soundscape, e.g., such that a pedestrian within the maximum range is considered in proximity of the vehicle.

Furthermore or in an alternative configuration, the pitch of the soundscape(s) may be modified based, at least in part, on the proximity of the pedestrian relative to the vehicle 10. In one instance, the pitch of the external soundscape may be modified based on the proximity of the pedestrian relative to the vehicle 10 as indicated by the external vehicle environment data 318A. For example, the pitch of the external soundscape may be increased in response to a determination that the pedestrian is in proximity to the vehicle 10 (e.g., within the static predetermined threshold, the algebraic determined maximum range, and/or the maximum range qualitatively determined by the AI algorithm(s) 330). It should be recognized that higher frequency noises are typically more irritating than lower frequency noise, at least within the audible range. Many theories hypothesize that humans have evolved to more readily identify sounds similar to cries from babies, animals, etc., all of which are high-frequency noises, as used herein. Thus, by increasing the frequency of the external soundscape when pedestrian(s) are within proximity of the vehicle, the resulting external soundscape is more noticeable by the pedestrian(s).

In some embodiments, the control logic 336 and/or method 402 may include modifying the soundscape(s) based, at least in part, on a number of pedestrians in proximity to the vehicle 10. For example, the sound intensity and/or sound pitch may be increased more in response to multiple pedestrians within proximity of the vehicle. The increase in the sound intensity and/or sound pitch may be proportional to the additional pedestrians within proximity of the vehicle. Alternatively, the increase in the sound intensity and/or sound pitch may be qualitatively determined by the AI algorithm(s) 330, such as based on the external vehicle environment data 318A, the estimated friction of the road, and/or a current speed of the vehicle 10. In some instances, the increase in the sound intensity and/or sound pitch may have a limit. For example, the external soundscape generated based on 15 pedestrians within proximity of the vehicle 10 may be the same or nearly the same as the soundscape generated based on 100 pedestrians within proximity of the vehicle 10. However, the 15 and 100 pedestrians are provided for example only, and different external environmental contexts may determine when additional pedestrians in proximity of the vehicle 10 do not result in altering the external soundscape. In some embodiments, an upper sound intensity limit and/or upper sound frequency limit may be qualitatively determined by the AI algorithm(s) 330, may be predetermined limits, and/or may be indicated by the associated occupant profile 340. The modification of the external soundscape may also be direction, e.g., the sound produced by external noise generator(s) 17A directed or pointed toward the pedestrian(s) may be modified or modified more than external noise generator(s) 17A directed or pointed elsewhere, the sound produced thereby not modified or modified less comparatively.

Additionally or alternatively, the control logic 336 and/or method 402 may include modifying the soundscape(s) based, at least in part, on one or more determined characteristics of the pedestrian(s) in proximity to the vehicle 10. In some instances, the AI algorithm(s) 330 may be utilized to determine the characteristic(s) of the pedestrian(s) based on the external environmental vehicle data 318A. In one example, the pedestrian(s) may be determined to be a senior citizen, over the predetermined age, suffer from hearing loss, or the like, and, in response, the AI algorithm(s) 330 may be configured to generate the external soundscape at an increased sound intensity and/or at lower pitch.

In some embodiments, the control logic 336 and/or method 402 may include modifying the soundscape(s) based, at least in part, on a proximity of an additional vehicle relative to the vehicle 10 and/or on the number of additional vehicles in proximity to the vehicle 10. For example, the AI algorithm(s) 330 may identify one or more additional vehicles within the external environment of the vehicle 10 and/or the position, orientation, or the like of the additional vehicle(s) relative to the vehicle 10. In one instance, the sound intensity of the external soundscape may be increased in response to a determination that the additional vehicle(s) is in proximity to the vehicle 10 (e.g., within a static predetermined threshold, an algebraic determined maximum range, and/or a maximum range qualitatively determined by the AI algorithm(s) 330) or the number of additional vehicles in proximity of the vehicle 10.

Additionally or alternatively, the pitch of the external soundscape may be decreased in response to a determination that the additional vehicle(s) is in proximity to the vehicle 10 (e.g., within the static predetermined threshold, the algebraic determined maximum range, and/or the maximum range qualitatively determined by the AI algorithm(s) 330) or the number of additional vehicles in proximity of the vehicle. It should be recognized that, while higher frequency noises are typically more irritating/noticeable than lower frequency noise, lower frequency noises better penetrate through barriers such as vehicle bodies due to the corresponding longer wavelength. Thus, by decreasing the frequency of the external soundscape when additional vehicle(s) are within proximity of the vehicle, the resulting external soundscape may be more noticeable by the operator(s) of the additional vehicle(s). The modification of the external soundscape may also be direction, e.g., the sound produced by external noise generator(s) 17A directed or pointed toward the additional vehicle(s) may be modified or modified more than external noise generator(s) 17A directed or pointed elsewhere, the sound produced thereby not modified or modified less comparatively.

Additionally or alternatively, the control logic 336 and/or method 402 may include modifying the soundscape(s) based, at least in part, on one or more determined characteristics of the additional vehicle(s) in proximity to the vehicle 10. In some instances, the AI algorithm(s) 330 may be utilized to determine the characteristic(s) of the additional vehicle(s) based on the external environmental vehicle data 318A. In one example, the additional vehicle(s) may be determined to be an open vehicle or partially open vehicle (e.g., a convertible, motorcycle, golf cart, or similar vehicle currently without a fully enclosed vehicle body). In response, the AI algorithm(s) 330 may be configured to generate the external soundscape at a decreased sound intensity and/or at higher pitch relative to the external soundscape generated in response to the determination of a fully enclosed additional vehicle(s).

Additionally or alternatively, the control logic 336 and/or method 402 may include modifying the soundscape(s) based, at least in part, on the vehicle parameter data 318C and/or utilizing the AI algorithm(s) 330. In one instance, the soundscape(s) may be further generated or modified based, at least in part, on a determined geographical location of the vehicle 10. Some geographical locations may be associated with a type of road, and/or the type of road may optionally, additionally, or alternatively be determined based partially on the external vehicle environment data 318A. For example, in response to a determination of an urban road used typically during city commutes, the control logic 336, method 402, and/or AI algorithm(s) 330 may be configured to generate the external soundscape at an increased sound intensity. In such situation, the control logic 336, method 402, and/or AI algorithm(s) 330 may be configured to generate the external soundscape at an increased or decreases sound pitch based on whether the urban road is a highway, interstate, freeway, etc. and/or the likelihood of pedestrians within proximity of the vehicle. As another example, in response to a determination of a rural road with increased wildlife density, the control logic 336, method 402, and/or AI algorithm(s) 330 may be configured to generate the external soundscape at an increased sound intensity and/or sound pitch. Thus, the modified external soundscape may help to repel deer, cows, horses, and the like from crossing the path of the vehicle 10. It should be appreciated that many kinds of wildlife are more sensitive to higher frequency noises than humans and may particularly avoid sounds at frequencies above the human audible range.

In some such embodiments or differently configured embodiments, the control logic 336 and/or method 402 may include determining or modifying the soundscape(s) based, at least in part, on one or more determined characteristic(s) of at least one other system of the vehicle 10 and/or associated with the system 100. It should be appreciated that many drivers of ICE vehicles utilize the noises produced by the ICE and/or ICE vehicle as feedback to determine the condition of the ICE and/or other components of a traditional ICE vehicle without the need to constantly look down to the dash, e.g., most drivers of manual vehicles shift without ever looking at the tachometer to determine that shifting is required. By modifying the soundscape(s), such as the internal soundscape, based on the characteristic(s) of the other system(s) of the vehicle 10, similar auditory feedback may be provided to the operator of the vehicle 10. Thus, the operator of the vehicle 10 may largely operate the vehicle based on “feel,” as is typically done with traditional ICE vehicles.

Generally, the sound intensity and/or sound pitch of the soundscape(s) may be determined or modified based on the vehicle parameter data 318C. The vehicle parameter data 318C may indicate the determined characteristic(s) of the other system(s), and/or the AI algorithm(s) 330 may determine the characteristic(s) of the other system(s) based on the vehicle parameter data 318C. The determined characteristic(s) of the other system(s) may include, without limitation, an available energy level of the vehicle 10, a current speed of the vehicle 10, a current direction of travel of the vehicle 10, a current gear of a power train of the vehicle 10, a current torque applied via the power train of the vehicle 10, a rate of a change in speed of the vehicle 10, a rate of a change in torque applied via the power train of the vehicle 10, a maintenance status of one or more components or other systems of the vehicle 10, a determined fault of the component(s) or other system(s) of the vehicle 10.

In several embodiments, the soundscape(s) may be determined or modified utilizing the AI algorithm(s) 330 and based on the determined characteristic(s) of the other system(s) of the vehicle 10. In one configuration, the soundscape(s) may be generated or modified based on the current speed of the vehicle 10. For example, a sound intensity of the external soundscape may be increased as the speed of the vehicle 10 increases. In one instance, the soundscape(s) may be generated and/or modified based, at least in part, on the available energy level of the vehicle 10. For example, the internal soundscape may be modified in response to the available energy level of the vehicle 10 failing below a predetermined threshold, such as 5%, 3%, or 1%. Alternatively, the internal soundscape may be modified in response to range determined from the available energy level failing below a predetermined threshold, such as 5 miles, 2 miles, or 1 mile or comparable distance(s) in kilometers. For instance, the external soundscape may be modified to mimic the sounds produced by an ICE vehicle running in a lean operating condition (e.g., a sputtering ICE vehicle about to run out of gas). Thus, the modification of the internal soundscape informs the operator of the vehicle 10 that the engine(s) of vehicle 10 will imminently stop without more fuel and/or charge and that the operator should immediately find a safe location to stop the vehicle 10, as a dead vehicle on the side of a road is preferable to a dead vehicle blocking the road. In an additional or alternative configuration, the soundscape(s) may be generated or modified based on maintenance data or fault data of other systems of the vehicle 10. For example, the internal soundscape may be modified to mimic a run down, out of tune, etc. ICE vehicle in response to certain error codes, failure to follow routine maintenance, and/or the like.

Additionally or alternatively, the soundscape(s) may be generated or modified based on the rate of a change in speed of the vehicle 10 and/or a rate of a change in torque applied via the power train of the vehicle 10. For example, the sound intensity and/or sound pitch may be increased in response to a positive change in speed of the vehicle 10, a positive rate of change in the speed of the vehicle 10 above a predetermined threshold, a positive change in torque applied by the power train of the vehicle 10, or a positive rate of change in torque applied by the power train of the vehicle 10 over a predetermined threshold. Thus, when an operator actuates the accelerator of the vehicle 10, resulting in increasing speed and/or torque, the sound intensity and/or sound pitch of the soundscape(s) may be increased. For example, the increase in the sound intensity or the sound pitch of the internal soundscape or degree thereof may provide feedback to the operator that the vehicle 10 is currently providing some or all of the desired increase in vehicle speed and/or torque. Contrarily, the lack of increase or a small increase in the sound intensity or the sound pitch of the internal soundscape in response to accelerator input provides feedback to the operator that the speed or torque of the vehicle is not increasing or increasing as much as the operator may desire. This feedback may be useful when determining whether to lane shift into a faster lane or wait until faster traffic passes the vehicle 10.

The external soundscape may be similarly modified based on the rate of a change in speed of the vehicle 10 and/or a rate of a change in torque to indicate to additional vehicles, pedestrians, etc. that the vehicle 10 is rapidly accelerating, slightly accelerating, or maintaining the same speed. Similarly, an increase in sound intensity in conjunction with a decrease in sound pitch of the soundscape(s), or degrees thereof, in response to a negative change in speed of the vehicle 10, a negative rate of change in the speed of the vehicle 10 above a predetermined threshold, a negative change in torque applied by the power train of the vehicle 10, or a negative rate of change in torque applied by the power train of the vehicle 10 may indicate engine breaking and/or a degree of engine breaking of the vehicle 10.

Referring still to FIGS. 3 and 4C, the control logic 336 and/or method 402 may include determining whether an operational status of the vehicle is suitable for on-road operation (method element 436). For example, operational status of the vehicle 10 suitable for on-road operation may include an ON status of a power supply of the vehicle 10, as described in greater detail above. Additionally or alternatively, the control logic 336 and/or method 402 may include producing, in response to a determination that the operational status of the vehicle is suitable for on-road operation, the soundscape utilizing the noise generator(s) while the operational status of the vehicle is suitable for on-road operation (method element 438). For example and in response to the determination that the operational status of the vehicle 10 is suitable for on-road operation, the external soundscape may be produced utilizing the external noise generator(s) 17A (see method element 440). Additionally or alternatively, the internal soundscape may be produced utilizing the internal noise generator(s) 17B in response to the determination that the operational status of the vehicle 10 is suitable for on-road operation (see method element 442).

Referring now to FIGS. 2 and 3 in combination, some embodiments of the control unit 22 including the on-road sound production module and/or method 402 may be configured to directly produce the internal and/or external soundscapes by directly providing operation control and/or power to the respective external noise generator(s) 17A and/or internal noise generator(s) 17B respectively. For example, the control unit 22 may be configured to provide operational control of the noise generator(s) 17 and associated audio components (e.g., amplifiers, preamplifiers, and the like) via implementation of a suitable audio control module and/or method 334. Alternatively, control unit 22 may communicate the generated soundscape(s), modified soundscape(s), and/or characteristics thereof to the audio control system 234 configured to implement the audio control module and/or method 334 to produce the generated soundscape(s) and/or modified soundscape(s) utilizing the noise generator(s) 17.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

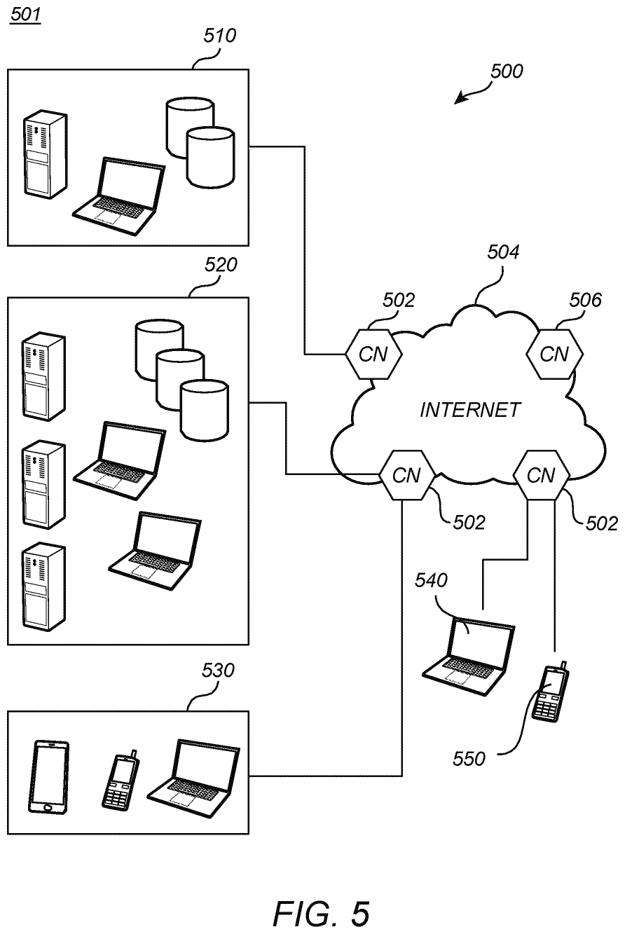

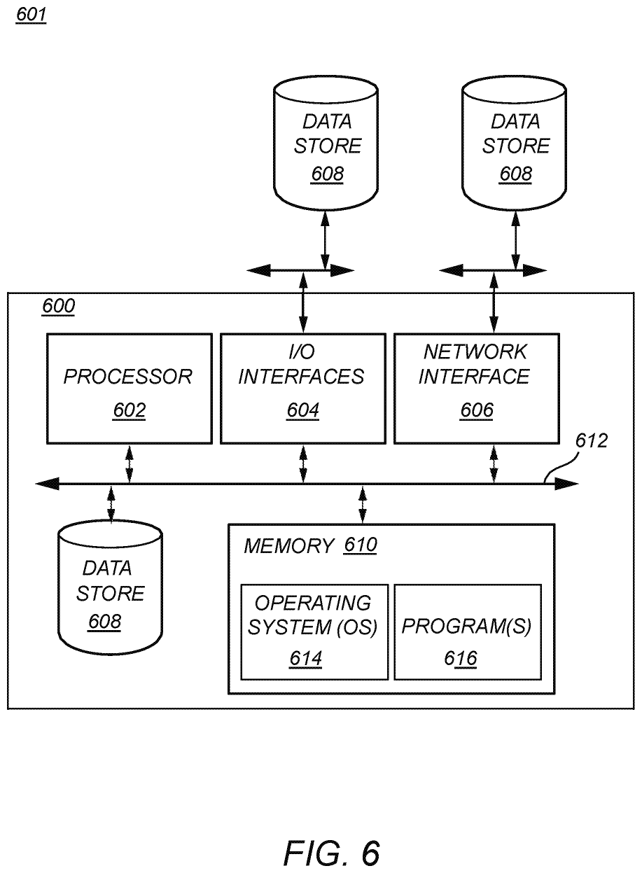

FIG. 5 is a network diagram of a cloud-based system 500 for implementing various cloud-based services of the present disclosure. The cloud-based system 500 includes one or more cloud nodes (CNs) 502 communicatively coupled to the Internet 504 or the like. The cloud nodes 502 may be implemented as a server 600 (as illustrated in FIG. 6) or the like and can be geographically diverse from one another, such as located at various data centers around the country or globe. Further, the cloud-based system 500 can include one or more central authority (CA) nodes 506, which similarly can be implemented as the server 600 and be connected to the CNs 502. For illustration purposes, the cloud-based system 500 can connect to a regional office 510, headquarters 520, various employee's homes 530, laptops/desktops 540, and mobile devices 550, each of which can be communicatively coupled to one of the CNs 502. These locations 510, 520, and 530, and devices 540 and 550 are shown for illustrative purposes, and those skilled in the art will recognize there are various access scenarios to the cloud-based system 500, all of which are contemplated herein. The devices 540 and 550 can be so-called road warriors, i.e., users off-site, on-the-road, etc. The cloud-based system 500 can be a private cloud, a public cloud, a combination of a private cloud and a public cloud (hybrid cloud), or the like.

Again, the cloud-based system 500 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 510, 520, and 530 and devices 540 and 550. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 500 is replacing the conventional deployment model. The cloud-based system 500 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 500 is illustrated herein as one example embodiment of a cloud-based system, and those of ordinary skill in the art will recognize the systems and methods described herein are not necessarily limited thereby.

FIG. 6 is a block diagram of a server 600, which may be used in the cloud-based system 500 (FIG. 5), in other systems, or stand-alone. For example, the CNs 502 (FIG. 5) and the central authority nodes 506 (FIG. 5) may be formed as one or more of the servers 600. The server 600 may be a digital computer that, in terms of hardware architecture, generally includes a processor 602, input/output (I/O) interfaces 604, a network interface 606, a data store 608, and memory 610. It should be appreciated by those of ordinary skill in the art that FIG. 6 depicts the server 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 may be, for example, but is not limited to, one or more buses or other wired or wireless connections, as is known in the art. The local interface 612 may have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 may be any custom made or commercially available processor, a central processing unit (CPU), an auxiliary processor among several processors associated with the server 600, a semiconductor-based microprocessor (in the form of a microchip or chipset), or generally any device for executing software instructions. When the server 600 is in operation, the processor 602 is configured to execute software stored within the memory 610, to communicate data to and from the memory 610, and to generally control operations of the server 600 pursuant to the software instructions. The I/O interfaces 604 may be used to receive user input from and/or for providing system output to one or more devices or components.

The network interface 606 may be used to enable the server 600 to communicate on a network, such as the Internet 504 (FIG. 5). The network interface 606 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 606 may include address, control, and/or data connections to enable appropriate communications on the network. A data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media. In one example, the data store 608 may be located internal to the server 600, such as, for example, an internal hard drive connected to the local interface 612 in the server 600. Additionally, in another embodiment, the data store 608 may be located external to the server 600 such as, for example, an external hard drive connected to the I/O interfaces 604 (e.g., a SCSI or USB connection). In a further embodiment, the data store 608 may be connected to the server 600 through a network, such as, for example, a network-attached file server.

The memory 610 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 610 may have a distributed architecture, where various components are situated remotely from one another but can be accessed by the processor 602. The software in memory 610 may include one or more software programs, each of which includes an ordered listing of executable instructions for implementing logical functions. The software in the memory 610 includes a suitable operating system (O/S) 614 and one or more programs 616. The operating system 614 essentially controls the execution of other computer programs, such as the one or more programs 616, and provides scheduling, input-output control, file and data management, memory management, and communication control and related services. The one or more programs 616 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

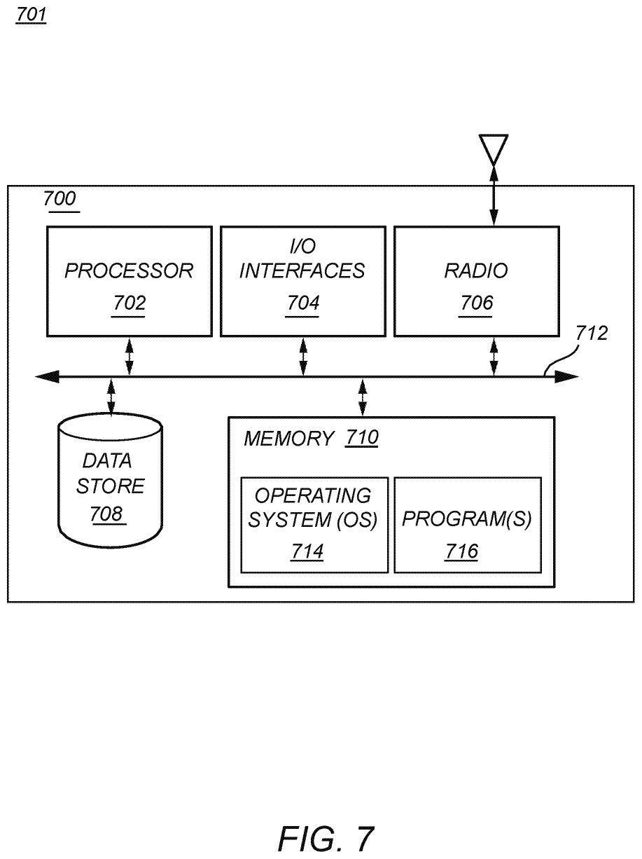

FIG. 7 is a block diagram of a user device 700, which may be used in the cloud-based system 500 (FIG. 5), as part of a network, or stand-alone. Again, the user device 700 can be a vehicle (e.g., one or more control units thereof), a smartphone, a tablet, a smartwatch, an Internet of Things (IoT) device, a laptop, a virtual reality (VR) headset, etc. The user device 700 can be a digital device that, in terms of hardware architecture, generally includes a processor 702, I/O interfaces 704, a radio 706, a data store 708, and memory 710. It should be appreciated by those of ordinary skill in the art that FIG. 7 depicts the user device 700 in an oversimplified manner, and a practical embodiment may include additional components and suitably configured processing logic to support known or conventional operating features that are not described in detail herein. The components (702, 704, 706, 708, and 710) are communicatively coupled via a local interface 712. The local interface 712 can be, for example, but is not limited to, one or more buses or other wired or wireless connections, as is known in the art. The local interface 712 can have additional elements, which are omitted for simplicity, such as controllers, buffers (caches), drivers, repeaters, and receivers, among many others, to enable communications. Further, the local interface 712 may include address, control, and/or data connections to enable appropriate communications among the aforementioned components.

The processor 702 is a hardware device for executing software instructions. The processor 702 can be any custom made or commercially available processor, a CPU, an auxiliary processor among several processors associated with the user device 700, a semiconductor-based microprocessor (in the form of a microchip or chipset), or generally any device for executing software instructions. When the user device 700 is in operation, the processor 702 is configured to execute software stored within the memory 710, to communicate data to and from the memory 710, and to generally control operations of the user device 700 pursuant to the software instructions. In an embodiment, the processor 702 may include a mobile optimized processor such as optimized for power consumption and mobile applications. The I/O interfaces 704 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 706 enables wireless communication to an external access device or network. Any number of suitable wireless data communication protocols, techniques, or methodologies can be supported by the radio 706, including any protocols for wireless communication. The data store 708 may be used to store data. The data store 708 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media.

Again, the memory 710 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 710 may incorporate electronic, magnetic, optical, and/or other types of storage media. Note that the memory 710 may have a distributed architecture, where various components are situated remotely from one another, but can be accessed by the processor 702. The software in memory 710 can include one or more software programs, each of which includes an ordered listing of executable instructions for implementing logical functions. In the example of FIG. 7, the software in the memory 710 includes a suitable operating system 714 and programs 716. The operating system 714 essentially controls the execution of other computer programs and provides scheduling, input-output control, file and data management, memory management, and communication control and related services. The programs 716 may include various applications, add-ons, etc. configured to provide end user functionality with the user device 700. For example, example programs 716 may include, but not limited to, a web browser, social networking applications, streaming media applications, games, mapping and location applications, electronic mail applications, financial applications, and the like. In a typical example, the end-user typically uses one or more of the programs 716 along with a network, such as the cloud-based system 500 (FIG. 5).

Again, embodiments of the disclosed systems and methods facilitate customization of on-road sound production for a vehicle by allowing an occupant to select a preferred sound file or provide the preferred sound file for generation of internal and/or external on-road sound. The generated on-road sound is intended to supplement noise generated by a quiet internal combustion engine, electric engine, or hybrid engine of the vehicle in question. The on-road sound may be generated based on the preferred sound file of the occupant, an environment surrounding the vehicle, an internal environment of the vehicle, vehicle parameter data, or a combination of the above. Thus, operators are permitted to select or provide the source sound files utilized to generate the external or internal on-road sounds, respectively. Based on the environment surrounding the vehicle, an internal environment of the vehicle, and/or vehicle parameter data, the on-road sound may be tailored to the current situation and operating condition of the vehicle to improve safety of the vehicle occupants, pedestrians in the vicinity of the vehicle, and occupants of other vehicles in the vicinity of the vehicle in question.

In some situations, the operator may not select or provide a preferred sound file, in which case the on-road sound may be generated from a stock sound file and altered based on some or all of the remaining considerations. Regardless of whether the operator has indicated a preferred sound file, the disclosed systems and methods still improve the safety of all parties involved by tailoring the generated on-road sound production for the current situation and environment of the vehicle. In an exemplary implementation, sound intensity, sound pitch, or the like of the on-road sound production may be determined or modified based on determined characteristics of the operator of the vehicle; the presence of, number of, or characteristics of pedestrians in the vicinity of the vehicle; and/or the presence of, number of, or characteristics of other vehicles in the vicinity of the vehicle.

By tailoring the external on-road sound production based on the external environment and/or operating condition of the vehicle, the vehicle can produce more road noise or road noise more likely to alert other vehicles or pedestrians based on characteristics of the other vehicles or pedestrians, changing circumstances, and/or the environment encountered by the vehicle. The tailored on-road sound production also provides information to the other vehicles or pedestrians with respect to the speed of the vehicle in question and whether the vehicle is currently or about to accelerate or engine break by mimicking how an internal combustion sounds when operating under similar conditions.

Furthermore, by tailoring the internal or cabin on-road sound production based on the current internal environment and/or operating condition of the vehicle, the vehicle can increase or decrease the volume and pitch of the internal on-road sound to account for ambient noise level and conditions of the cabin of the vehicle. For example, lower frequency on-road sound may be more easily noticed than higher frequency sound if there is a crying baby in the cabin of the vehicle. In several instances, tailoring the internal on-road sound production based on characteristics of the operator may tailor the pitch of the internal on-road sound production to frequency bands more easily noticed by the operator, such as an operator with some degree of hearing loss. The tailored the internal on-road sound may also provide feedback to the operator indicating the operating condition of the vehicle, whether the vehicle will accelerate as the operator desires or expects, whether the vehicle is engine breaking or the degree of engine breaking, or the like.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Clauses and/or Claims for all purposes.
Clause 1: A vehicle comprising a system for customization of on-road sound production for the vehicle.
Clause 2: The vehicle of any one of the previous clauses further comprising at least one noise generator supported relative to the vehicle and configured to produce a soundscape in an environment of the vehicle.
Clause 3: The vehicle of any one of the previous clauses, wherein the at least one noise generator includes an external speaker configured to produce an external soundscape in an external environment surrounding the vehicle.
Clause 4: The vehicle of any one of the previous clauses, wherein the at least one noise generator includes a cabin speaker configured to produce an internal soundscape in a cabin of the vehicle.
Clause 5: The vehicle of any one of the previous clauses further comprising at least one external environmental sensor supported relative to the vehicle.
Clause 6: The vehicle of any one of the previous clauses, wherein the at least one external environmental sensor comprises at least one of a camera, a LiDAR sensor, a radar sensor, a microphone, a proximity sensor, an impact sensor, an infrared sensor, an acoustic sensor, or an optical sensor.
Clause 7: The vehicle of any one of the previous clauses further comprising at least one cabin sensor supported relative to the vehicle.
Clause 8: The vehicle of any one of the previous clauses, wherein the at least one cabin sensor comprises at least one of a camera, a LiDAR sensor, a radar sensor, a microphone, a proximity sensor, an infrared sensor, an acoustic sensor, or an optical sensor.
Clause 9: A system for customization of on-road sound production for a vehicle.
Clause 10: The system of any one of the previous clauses, the system comprising at least one noise generator supported relative to the vehicle and configured to produce a soundscape in an environment of the vehicle.
Clause 11: The system of any one of the previous clauses, wherein the at least one noise generator includes an external speaker.
Clause 12: The system of any one of the previous clauses, wherein the at least one noise generator includes a cabin speaker.
Clause 13: The system of any one of the previous clauses, further comprising at least one memory storing instructions that, when executed by one or more processors, cause the one or more processors to carry out at least one step.
Clause 14: The system of any one of the previous clauses, wherein the at least one step comprises: generating the soundscape from at least one sound file also stored in the at least one memory based on at least one of an indication of a user-preferred sound file of a plurality of sounds files stored in the at least one memory or an environmental context surrounding the vehicle.
Clause 15: The system of any one of the previous clauses, wherein the at least on sound file comprises at least one of an MP3 file or an MP4 file.
Clause 16: The system of any one of the previous clauses, wherein the at least one step comprises: generating the soundscape from at least one sound file also stored in the at least one memory based on an indication of a user-preferred sound file of a plurality of sounds files stored in the at least one memory.
Clause 17: The system of any one of the previous clauses, wherein the at least one step comprises: generating the soundscape from at least one sound file also stored in the at least one memory based on an environmental context surrounding the vehicle.
Clause 18: The system of any one of the previous clauses, wherein the at least one step comprises: determining whether an operational status of the vehicle is suitable for on-road operation.
Clause 19: The system of any one of the previous clauses, wherein the operational status of the vehicle suitable for on-road operation comprises an ON status of a power supply of the vehicle.
Clause 20: The system of any one of the previous clauses, wherein the at least one step comprises: producing, in response to a determination that the operational status of the vehicle is suitable for on-road operation, the soundscape utilizing the at least one noise generator while the operational status of the vehicle is suitable for on-road operation.
Clause 21: The system of any one of the previous clauses, wherein the generated soundscape is an external soundscape.
Clause 21.1: The system of any one of the previous clauses, wherein a sound intensity of the external soundscape exceeds a minimum regulatory requirement by a determined amount.
Clause 21.2: The system of any one of the previous clauses, wherein the determined amount is a predetermined amount.
Clause 21.3: The system of any one of the previous clauses, wherein the predetermined amount is a stock predetermined amount.
Clause 21.4: The system of any one of the previous clauses, wherein the predetermined amount is indicated by an occupant profile associated with an occupant of the vehicle.
Clause 21.5: The system of any one of the previous clauses, wherein the determined amount is based, at least in part, on the environmental context surrounding the vehicle.
Clause 21.6: The system of any one of the previous clauses, wherein the determined amount is generated utilizing an artificial intelligence algorithm.
Clause 21.6: The system of any one of the previous clauses, wherein, in response to a determination that the environmental context surrounding the vehicle is an unregulated environment, the sound intensity is of the external soundscape is selectively reduced below the minimum regulatory requirement.
Clause 22: The system of any one of the previous clauses, wherein the generated soundscape mimics an internal combustion engine noise.
Clause 23: The system of any one of the previous clauses, wherein the at least one noise generator is configured to produce the external soundscape in an external environment surrounding the vehicle.
Clause 24: The system of any one of the previous clauses, wherein the generated soundscape is an internal soundscape.
Clause 25: The system of any one of the previous clauses, wherein the at least one noise generator is configured to produce the internal soundscape in a cabin of the vehicle.
Clause 26: The system of any one of the previous clauses, wherein the at least one step comprises: generating the external soundscape from the at least one sound file also stored in the at least one memory based on at least one of an indication of a user-preferred external sound file of the plurality of sounds files stored in the at least one memory or the environmental context surrounding the vehicle.
Clause 27: The system of any one of the previous clauses, wherein the at least one step comprises: generating the external soundscape from the at least one sound file also stored in the at least one memory based on an indication of a user-preferred external sound file of the plurality of sounds files stored in the at least one memory.
Clause 28: The system of any one of the previous clauses, wherein the at least one step comprises: generating the external soundscape from the at least one sound file also stored in the at least one memory based on the environmental context surrounding the vehicle.
Clause 29: The system of any one of the previous clauses, wherein the environmental context surrounding the vehicle comprises an ambient noise level of the external environment surrounding the vehicle.
Clause 30: The system of any one of the previous clauses, wherein the at least one step comprises: producing, in response to the determination that the operational status of the vehicle is suitable for on-road operation, the external soundscape utilizing the at least one noise generator while the operational status of the vehicle is suitable for on-road operation.
Clause 31: The system of any one of the previous clauses, wherein the at least one step comprises: producing, in response to the determination that the operational status of the vehicle is suitable for on-road operation, the external soundscape utilizing the exterior speaker while the operational status of the vehicle is suitable for on-road operation.
Clause 32: The system of any one of the previous clauses, wherein the at least one step comprises: determining a relative balance of a sound intensity of the external soundscape and a sound intensity of the internal soundscape based on at least one of the environmental context surrounding the vehicle or an environmental context of the cabin of the vehicle.
Clause 33: The system of any one of the previous clauses, wherein the sound intensity of the external soundscape defines at least one of an average sound intensity of the external soundscape, a minimum sound intensity of the external soundscape, or a maximum sound intensity of the external soundscape.
Clause 34: The system of any one of the previous clauses, wherein the sound intensity of the external soundscape defines an average sound intensity of the external soundscape.
Clause 35: The system of any one of the previous clauses, wherein the sound intensity of the external soundscape defines a minimum sound intensity of the external soundscape.
Clause 36: The system of any one of the previous clauses, wherein the sound intensity of the external soundscape defines a maximum sound intensity of the external soundscape.
Clause 37: The system of any one of the previous clauses, wherein the sound intensity of the internal soundscape defines at least one of an average sound intensity of the internal soundscape, a minimum sound intensity of the internal soundscape, or a maximum sound intensity of the internal soundscape.
Clause 38: The system of any one of the previous clauses, wherein the sound intensity of the internal soundscape defines an average sound intensity of the internal soundscape.
Clause 39: The system of any one of the previous clauses, wherein the sound intensity of the internal soundscape defines a minimum sound intensity of the internal soundscape.
Clause 40: The system of any one of the previous clauses, wherein the sound intensity of the internal soundscape defines a maximum sound intensity of the internal soundscape.
Clause 41: The system of any one of the previous clauses, wherein the at least one step comprises: determining a relative balance of a sound intensity of the external soundscape and a sound intensity of the internal soundscape based the environmental context surrounding the vehicle.
Clause 42: The system of any one of the previous clauses, wherein the at least one step comprises: determining a relative balance of a sound intensity of the external soundscape and a sound intensity of the internal soundscape based on an environmental context of the cabin of the vehicle.
Clause 43: The system of any one of the previous clauses, wherein the at least one step comprises: modifying a relative balance of a sound intensity of the external soundscape and a sound intensity of the internal soundscape based on at least one of the environmental context surrounding the vehicle or an environmental context of the cabin of the vehicle.
Clause 44: The system of any one of the previous clauses, wherein the at least one step comprises: modifying a relative balance of a sound intensity of the external soundscape and a sound intensity of the internal soundscape based the environmental context surrounding the vehicle.
Clause 45: The system of any one of the previous clauses, wherein the at least one step comprises: modifying a relative balance of a sound intensity of the external soundscape and a sound intensity of the internal soundscape based on an environmental context of the cabin of the vehicle.
Clause 46: The system of any one of the previous clauses, wherein the soundscape is generated from at least one of a user-selected or a user-provided sound file of the plurality of sound files.
Clause 47: The system of any one of the previous clauses, wherein the soundscape is generated from a user-selected sound file of the plurality of sound files.
Clause 48: The system of any one of the previous clauses, wherein the soundscape is generated from a user-provided sound file of the plurality of sound files.
Clause 49: The system of any one of the previous clauses, further comprising at least one external environmental sensor supported relative to the vehicle.
Clause 50: The system of any one of the previous clauses, wherein the at least one external environmental sensor comprises at least one of a camera, a LiDAR sensor, a radar sensor, a microphone, a proximity sensor, an impact sensor, an infrared sensor, an acoustic sensor, or an optical sensor.
Clause 51: The system of any one of the previous clauses, wherein the at least one step comprises: receiving data communicated from the at least one external environmental sensor and indicating the environmental context surrounding the vehicle.
Clause 52: The system of any one of the previous clauses, wherein the soundscape is generated utilizing an artificial intelligence algorithm.
Clause 53: The system of any one of the previous clauses, wherein the soundscape is generated based on the data communicated from the at least one external environmental sensor.
Clause 54: The system of any one of the previous clauses, wherein generating the soundscape based on the environmental context surrounding the vehicle comprises modifying at least one of a sound intensity or a pitch of the soundscape based on the environmental context surrounding the vehicle.
Clause 55: The system of any one of the previous clauses, wherein generating the soundscape based on the environmental context surrounding the vehicle comprises modifying a sound intensity of the soundscape based on the environmental context surrounding the vehicle.
Clause 56: The system of any one of the previous clauses, wherein the at least one sound file indicates an initial sound intensity of the soundscape, and wherein modifying the sound intensity of the soundscape comprises generating the soundscape defining a modified sound intensity.
Clause 57: The system of any one of the previous clauses, wherein modifying a sound intensity of the soundscape comprises altering the soundscape from an initial state defining an initial sound intensity of the soundscape to a modified state defining a modified sound intensity.
Clause 58: The system of any one of the previous clauses, wherein the modified sound intensity is different than the initial sound intensity.
Clause 59: The system of any one of the previous clauses, wherein the initial sound intensity defines at least one of an average initial sound intensity, a minimum initial sound intensity, or a maximum initial sound intensity; and wherein the modified sound intensity defines at least one of an average modified sound intensity, a minimum modified sound intensity, or a maximum modified sound intensity.
Clause 60: The system of any one of the previous clauses, wherein the initial sound intensity defines an average initial sound intensity, and wherein the modified sound intensity defines an average modified sound intensity.
Clause 61: The system of any one of the previous clauses, wherein the initial sound intensity defines a minimum initial sound intensity, and wherein the modified sound intensity defines a minimum modified sound intensity.
Clause 62: The system of any one of the previous clauses, wherein the initial sound intensity defines a maximum initial sound intensity, and wherein the modified sound intensity defines a maximum modified sound intensity.
Clause 63: The system of any one of the previous clauses, wherein generating the soundscape based on the environmental context surrounding the vehicle comprises modifying a pitch of the soundscape based on the environmental context surrounding the vehicle.
Clause 64: The system of any one of the previous clauses, wherein the at least one sound file indicates an initial average sound frequency, and wherein modifying a pitch of the soundscape comprises generating the soundscape defining a modified average sound frequency.
Clause 65: The system of any one of the previous clauses, wherein modifying a pitch of the soundscape comprises altering the soundscape from an initial state defining an initial average sound frequency to a modified state defining a modified average sound frequency.
Clause 66: The system of any one of the previous clauses, wherein the modified average sound frequency is different than the initial average sound frequency.
Clause 67: The system of any one of the previous clauses, wherein the sound intensity is modified based, at least in part, on a proximity of a pedestrian relative to the vehicle.
Clause 68: The system of any one of the previous clauses, wherein the pitch of the soundscape is modified based, at least in part, on a proximity of a pedestrian relative to the vehicle.
Clause 69: The system of any one of the previous clauses, wherein the sound intensity is modified based, at least in part, on a number of pedestrians in proximity of the vehicle.
Clause 70: The system of any one of the previous clauses, wherein the pitch of the soundscape is modified based, at least in part, on a proximity of an additional vehicle relative to the vehicle.
Clause 71: The system of any one of the previous clauses, wherein the sound intensity is modified based, at least in part, on a proximity of an additional vehicle relative to the vehicle.
Clause 72: The system of any one of the previous clauses, wherein the sound intensity is modified based, at least in part, on a number of additional vehicles in proximity to the vehicle.
Clause 73: The system of any one of the previous clauses, wherein the pitch of the soundscape is modified based, at least in part, on what type of vehicle the additional vehicle is configured as.
Clause 74: The system of any one of the previous clauses, wherein the sound intensity is modified based, at least in part, on what type of vehicle the additional vehicle is configured as.
Clause 75: The system of any one of the previous clauses, wherein the soundscape is further generated based, at least in part, on a determined geographical location of the vehicle.
Clause 76: The system of any one of the previous clauses, wherein the soundscape is further generated based, at least in part, on a determined characteristic of at least one system of the vehicle.
Clause 78: The system of any one of the previous clauses, wherein the sound intensity is modified based, at least in part, on a determined characteristic of at least one system of the vehicle.
Clause 79: The system of any one of the previous clauses, wherein the pitch of soundscape is modified based, at least in part, on a determined characteristic of at least one system of the vehicle.
Clause 80: The system of any one of the previous clauses, wherein the determined characteristic of the least one system of the vehicle comprises at least one of an available energy level of the vehicle, a current speed of the vehicle, a current direction of travel of the vehicle, a current gear of the power train of the vehicle, a current torque applied via the power train of the vehicle, a rate of a change in speed of the vehicle, a rate of a change in torque applied via the power train of the vehicle, a maintenance status of at least one component or system of the vehicle, a determined fault of at least one component or system of the vehicle,
Clause 81: The system of any one of the previous clauses, wherein the soundscape is further generated based, at least in part, on an available energy level of the vehicle.
Clause 82: The system of any one of the previous clauses, wherein the soundscape is further generated based, at least in part, on an identification of an occupant of the vehicle.
Clause 83: The system of any one of the previous clauses, wherein the at least one step comprises: identify an occupant profile associated with an occupant of the vehicle.
Clause 84: The system of any one of the previous clauses, wherein the occupant profile indicates at least one of desired sound intensity, a desired range of sound intensity, an average sound intensity, a minimum sound intensity, or a maximum sound intensity of the soundscape.
Clause 85: The system of any one of the previous clauses, wherein the occupant profile indicates a desired relative balance of a sound intensity of the external soundscape and a sound intensity of the internal soundscape.
Clause 86: The system of any one of the previous clauses, wherein the occupant profile indicates at least one of a desired pitch, a desired pitch range, a desired average sound frequency of the soundscape, a minimum sound frequency of the soundscape, or a maximum sound frequency of the soundscape.
Clause 87: The system of any one of the previous clauses, wherein the desired sound intensity of the soundscape is different than at least one of a stock sound intensity or an additional desired sound intensity indicated by an additional occupant profile.
Clause 88: The system of any one of the previous clauses, wherein the desired sound intensity of the soundscape is different than a stock sound intensity.
Clause 89: The system of any one of the previous clauses, wherein the desired sound intensity of the soundscape is different than an additional desired sound intensity indicated by an additional occupant profile.
Clause 90: The system of any one of the previous clauses further comprising at least one cabin sensor supported relative to the vehicle.
Clause 91: The system of any one of the previous clauses, wherein the at least one cabin sensor comprises at least one of a camera, a LiDAR sensor, a radar sensor, a microphone, a proximity sensor, an infrared sensor, an acoustic sensor, or an optical sensor.
Clause 92: The system of any one of the previous clauses, wherein the at least one step comprises: receive data communicated from the at least one cabin sensor and indicating at least one characteristic of an occupant of the vehicle.
Clause 93: The system of any one of the previous clauses, wherein the soundscape is generated utilizing an artificial intelligence algorithm.
Clause 94: The system of any one of the previous clauses, wherein the soundscape is generated based on the data indicating the at least one characteristic of the occupant.
Clause 95: The system of any one of the previous clauses, wherein the soundscape is generated utilizing an artificial intelligence algorithm and further based on the data indicating the at least one characteristic of the occupant.
Clause 96: The system of any one of the previous clauses, wherein the at least one step comprises: receiving an indication of a user-preferred sound file of a plurality of sounds files also stored in the at least one memory.
Clause 97: The system of any one of the previous clauses, wherein the indication of the user-preferred sound file includes at least one of a user-selected or user-provided sound file of the plurality of sound files.
Clause 98: A non-transitory computer-readable medium comprising instructions stored in at least one memory and executed by one or more processors to carry out at least one step from any one of Clause 14-97.

What is claimed is:

1. A system for customization of on-road sound production for a vehicle, the system comprising:
at least one noise generator supported relative to the vehicle and configured to produce a soundscape in an environment of the vehicle; and
at least one memory storing instructions that, when executed by one or more processors, cause the one or more processors to:
generate the soundscape from at least one sound file also stored in the at least one memory based on at least one of an indication of a user-preferred sound file of a plurality of sounds files stored in the at least one memory or an environmental context surrounding the vehicle,
determine whether an operational status of the vehicle is suitable for on-road operation; and
produce, in response to a determination that the operational status of the vehicle is suitable for on-road operation, the soundscape utilizing the at least one noise generator while the operational status of the vehicle is suitable for on-road operation.

2. The system of claim 1, wherein the generated soundscape is an external soundscape, and the at least one noise generator includes an external speaker configured to produce the external soundscape in an external environment surrounding the vehicle.

3. The system of claim 2, wherein a sound intensity of the external soundscape exceeds a minimum regulatory requirement by a determined amount.

4. The system of claim 1, wherein the generated soundscape is an internal soundscape, and the at least one noise generator includes an internal noise generator configured to produce the internal soundscape in an internal environment of the vehicle.

5. The system of claim 4, wherein the at least one noise generator further includes an exterior speaker configured to produce an external soundscape in an external environment surrounding the vehicle, and wherein the instructions executed by one or more processors further cause the one or more processors to:
generate the external soundscape from the at least one sound file also stored in the at least one memory based on at least one of an indication of a user-preferred external sound file of the plurality of sounds files stored in the at least one memory or the environmental context surrounding the vehicle, and
produce, in response to the determination that the operational status of the vehicle is suitable for on-road operation, the external soundscape utilizing the exterior speaker while the operational status of the vehicle is suitable for on-road operation.

6. The system of claim 5, wherein the instructions executed by one or more processors further cause the one or more processors to:
modify or determine a relative balance of a sound intensity of the external soundscape and a sound intensity of the internal soundscape based on at least one of the environmental context surrounding the vehicle or an environmental context of the internal environment of the vehicle.

7. The system of claim 1, wherein the soundscape is generated from at least one of a user-selected or a user-provided sound file of the plurality of sound files.

8. The system of claim 1, wherein the system further comprises at least one external environmental sensor supported relative to the vehicle, and wherein the instructions executed by one or more processors further cause the one or more processors to:
receive data communicated from the at least one external environmental sensor and indicating the environmental context surrounding the vehicle,
wherein the soundscape is generated utilizing an artificial intelligence algorithm and further based on the data communicated from the at least one external environmental sensor.

9. The system of claim 1, wherein generating the soundscape based on the environmental context surrounding the vehicle comprises modifying at least one of a sound intensity or a pitch of the soundscape based on the environmental context surrounding the vehicle.

10. The system of claim 8, wherein the sound intensity is modified based, at least in part, on a proximity of a pedestrian relative to the vehicle.

11. The system of claim 1, wherein the soundscape is further generated based, at least in part, on an available energy level of the vehicle.

12. The system of claim 1, wherein the instructions executed by one or more processors further cause the one or more processors to:
identify an occupant profile associated with an occupant of the vehicle;
wherein the occupant profile indicates a desired sound intensity of the soundscape different than at least one of a stock sound intensity or an additional desired sound intensity indicated by an additional occupant profile.

13. The system of claim 1, wherein the system further comprises at least one internal environmental sensor supported relative to the vehicle, and wherein the instructions executed by one or more processors further cause the one or more processors to:
receive data communicated from the at least one internal environmental sensor and indicating at least one characteristic of an occupant of the vehicle,
wherein the soundscape is generated utilizing an artificial intelligence algorithm and further based on the data indicating the at least one characteristic of the occupant.

14. A non-transitory computer-readable medium comprising instructions stored in at least one memory and executed by one or more processors to carry out steps, the steps comprising:
receiving data communicated from at least one external vehicle environmental sensor and indicating an environmental context surrounding a vehicle;
generating a soundscape from at least one sound file also stored in the at least one memory based on the received data indicating the environmental context surrounding the vehicle;
determining whether an operational status of the vehicle is suitable for on-road operation; and
producing, in response to a determination that the operational status of the vehicle is suitable for on-road operation, the soundscape utilizing at least one noise generator supported relative to the vehicle while the operational status of the vehicle is suitable for on-road operation.

15. The non-transitory computer-readable medium of claim 14, wherein the generated soundscape is at least one of:
an external soundscape, and the at least one noise generator includes an external speaker configured to produce the external soundscape in an external environment surrounding the vehicle, or
an internal soundscape, and the at least one noise generator includes an internal noise generator configured to produce the internal soundscape in an internal environment of the vehicle.

16. The non-transitory computer-readable medium of claim 14, wherein the soundscape is generated utilizing an artificial intelligence algorithm.

17. The non-transitory computer-readable medium of claim 14, wherein generating the soundscape based on the environmental context surrounding the vehicle comprises modifying a sound intensity of the soundscape based on the environmental context surrounding the vehicle.

18. A non-transitory computer-readable medium comprising instructions stored in at least one memory and executed by one or more processors to carry out steps, the steps comprising:
receiving an indication of a user-preferred sound file of a plurality of sounds files also stored in the at least one memory;
generating a soundscape from the at least one sound file also stored in the at least one memory based on the indication of the user-preferred sound file;
determining whether an operational status of the vehicle is suitable for on-road operation; and
producing, in response to a determination that the operational status of the vehicle is suitable for on-road operation, the soundscape utilizing at least one noise generator supported relative to the vehicle while the operational status of the vehicle is suitable for on-road operation.

19. The non-transitory computer-readable medium of claim 18, wherein the indication of the user-preferred sound file includes at least one of a user-selected or a user-provided sound file of the plurality of sound files.

20. The non-transitory computer-readable medium of claim 18, the steps further comprising:
receiving data communicated from at least one internal environmental sensor and indicating at least one characteristic of an occupant of the vehicle,
wherein the soundscape is generated utilizing an artificial intelligence algorithm and further based on the data indicating the at least one characteristic of the occupant.
